(19) United States
(12) Patent Application Publication
(10) Pub. No.: US 2024/0400835 A1
(43) Pub. Date: Dec. 5, 2024

(54) WATER-BASED PRIMER-SURFACER AND USES THEREOF

(71) Applicant: PPG Industries Ohio, Inc., Cleveland, OH (US)

(72) Inventor: Wei Zhao, South Milwaukee, WI (US)

(73) Assignee: PPG Industries Ohio, Inc., Cleveland, OH (US)

(21) Appl. No.: 18/700,369

(22) PCT Filed: Oct. 6, 2022
(86) PCT No.: PCT/US2022/077659

§ 371 Date: Apr. 11, 2024

Related U.S. Application Data
(60) Provisional application No. 63/255,026, filed on Oct. 13, 2021.

(51) Int. Cl. C09D 5/00; C09D 5/18; C09D 7/43; C09D 7/45; C09D 7/47; C09D 175/06; C09D 175/14

(52) U.S. Cl. CPC C09D 5/002; C09D 5/18; C09D 7/43; C09D 7/45; C09D 7/47; C09D 175/06; C09D 175/14

(57) ABSTRACT

Water-based compositions useful as primer-surfacer precursor compositions and primer-surfacer coatings are disclosed. The compositions are based on carboxylic acid and aziridine or carbodiimide curing chemistries. The primer-surfacer coating exhibit excellent adhesion to polymeric substrates and to water-based or solvent-based topcoats. The primer-surfacer compositions can be used to level surfaces.

### CROSS-REFERENCE TO RELATED APPLICATIONS

This application claims the benefit under 35 U.S.C. § 119 (e) of U.S. Provisional Application No. 63/255,026 filed on Oct. 13, 2021 which is incorporated by reference in its entirety.

### FIELD

Water-based compositions useful as primer and surfacer coatings are disclosed. The compositions are based on carboxylic acid and aziridine or carbodiimide curing chemistries. The compositions exhibit excellent adhesion to polymeric substrates and to water-based and to solvent-based topcoats.

### BACKGROUND

Additive manufacturing is increasingly being used to manufacture complex parts. Additively manufactured parts can have surface features with depth profiles from 15 mils to 20 mils (381 μm to 508 μm) resulting from fabricating the parts layer by layer. It is desirable that the surfaces be smooth. Application of a primer-surfacer can fill in the rough surface profiles and provide a higher film thickness without surface defects such as mud cracking or shrinking caused by mechanical smoothing methods. The surface with a layer of a primer-surfacer coating can have a lower surface profile that can then be used as is or can be abraded. A topcoat can be applied to the smooth surface.

### SUMMARY

According to the present invention, a primer-surfacer precursor composition comprises a carboxyl-functional polyurethane prepolymer; a carboxyl-functional acrylic copolymer; an acrylic, a polyester polyol, or a combination thereof; and water.

According to the present invention, a primer-surfacer coating comprises a primer-surfacer coating prepared from the primer-surfacer composition according to the present invention.

According to the present invention, a two-part primer-surfacer system comprises a first part, wherein the first part comprises the primer-surfacer precursor composition according to the present invention; and a second part wherein the second part comprises a crosslinker, wherein the crosslinker comprises a polyaziridine, a carbodiimide, or a combination thereof.

According to the present invention, a multilayer coating comprises the primer-surfacer coating according to the present invention; and a coating overlying the primer-surfacer coating.

According to the present invention, a method of coating a substrate comprises applying the primer-surfacer composition according to the present invention to a substrate; and curing the applied primer-surfacer composition to provide a primer-surfacer coating.

According to the present invention, a method of leveling a surface comprises applying the primer-surfacer composition according to the present invention to a surface; curing the applied primer-surfacer composition to provide a leveled surface.

### BRIEF DESCRIPTION OF THE DRAWINGS

Those skilled in the art will understand that the drawings described herein are for illustration purposes only. The drawings are not intended to limit the scope of the present disclosure.

FIGS. 1A-1D show photographs of (A) panel fabricated using three-dimensional printing; (B) a panel with a primer-surfacer coating provided by the present disclosure; (C) a panel having an abraded primer-surfacer coating; and (D) a panel after a topcoat was applied to the abraded primer-surfacer coating.

FIGS. 2A-2D show photographs of test panels used to evaluate adhesion of a primer-surfacer provided by the present disclosure to various substrates and topcoats. The materials used and conditions used for the test panels is described in Example 1.

FIGS. 3A1-3B2 show the results of adhesion tests on primer-surfacer coatings cured under different conditions and following exposure to different test conditions. Details of the materials and test conditions are described in Example 1.

FIGS. 4A1-4B2 show the results of adhesion tests on primer-surfacer coatings cured under different conditions and following exposure to different test conditions. Details of the materials and test conditions are described in Example 1.

FIGS. 5A-5B show the results of adhesion tests on primer-surfacer coatings cured under different conditions and following exposure to different test conditions. Details of the materials and test conditions are described in Example 1.

FIGS. 6A1-6B2 show the results of adhesion tests on primer-surfacer coatings cured under different conditions and following exposure to different test conditions. Details of the materials and test conditions are described in Example 1.

FIGS. 7A1-7B2 show the results of adhesion tests on coatings cured under different conditions and following exposure to different test conditions. Details of the materials and test conditions are described in Example 1.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

When reference is made to a chemical group defined, for example, by a number of carbon atoms, the chemical group is intended to include all sub-ranges of carbon atoms as well as a specific number of carbon atoms. For example, a C₂₋₁₀ alkanediyl includes a C₂₋₄ alkanediyl, C₅₋₇ alkanediyl, and other sub-ranges, a C₂ alkanediyl, a C₆ alkanediyl, and alkanediyls having other specific number(s) of carbon atoms from 2 to 10.

“Hydroxyl number” refers to the hydroxyl group content of one gram of a polyol. Hydroxyl number is determined by reacting a known mass of a polyol with an anhydride that generates an acid, that acid adduct is titrated with KOH. The acetic anhydride method is described in ASTM E222 and/or ASTM D4274.

“Number average molecular weight” refers to the total weight of a material dived by the number of molecules in the material and can be determined using gel permeation chromatography.

“Dispersion” refers to a chemical system in which particles are dispersed in a continuous phase of a different composition or state.

Specific gravity is determined according to ISO 787-11.

“Volatile organic content” (VOC) refers to is defined in 40 Code of Federal Regulations Part 15.100 (s) as any compound of carbon, excluding carbon monoxide, carbon dioxide, carbonic acid, metallic carbides or carbonates, and ammonium carbonate, which participates in atmospheric photochemical reactions.

“Carboxyl-functional” refers to the presence of carboxyl groups-COOH. For example, a carboxyl-functional prepolymer can have one or more-COOH groups.

“Hydroxyl equivalent weight” refers to the number of grams of a given product that contains one equivalent of hydroxyl groups. The hydroxyl equivalent weight is 56100/OH.

“Hydroxyl value” refers to the milligrams of potassium hydroxide required to neutralize the acetic acid taken up on acetylation of one gram of a chemical substance that contains free hydroxyl groups.

Functionality refers to the number functional groups, such as number of OH groups per molecule.

The viscosity is determined using a Brookfield LVT viscometer with No. 3 spindle and 60 revolutions per minute (RPM) at 20° C.

The solids content is determined according to ISO 3251.

The gloss is determined using a BYK Haze-gloss 4601 in accordance with ISO 2813.

The particle size is determined by dynamic light scattering using a Malvern Autosizer Lo-C.

A primer-surfacer precursor composition refers to a composition comprising reactants other than the polyaziridine and/or polycarbodiimide crosslinker. A primer-surfacer composition refers to all components including the primer-surfacer precursor composition and the crosslinker. The primer-surfacer precursor composition and the crosslinker can be provide as separate components such as two separate components (2K) that are combined and mixed before use to provide the primer-surfacer composition. The primer-surfacer composition can be applied to a substrate such as by spraying. The applied primer-surfacer composition can be dried to provide a cured primer-surfacer coating. After a primer-surfacer composition is applied to a substrate, the solvent evaporates causing the crosslinking reactions to accelerate to form the cured primer-surfacer coating.

Solvent refers to water and organic solvent.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

Two-part (2K) isocyanate-free, low volatile organic content (VOC), water-based primer-surfacer compositions prepared from a self-crosslinking carboxyl-functional polyurethane dispersion and a carboxyl-functional acrylic dispersion, and an acrylic copolymer and/or a polyester polyol reacted with a polyaziridine or carbodiimide crosslinker are disclosed. The primer-surfacer coatings exhibit excellent adhesion to polar polymeric substrates, and to water-based and solvent based topcoats. The primer-surfacer coating compositions can be used to level surface features of a manufactured part and to enhance adhesion of an overlying topcoat. The primer-surfacer compositions can be applied to a high film build such as to a dry film thickness from 25 mils to 40 mils (0.64 mm to 1.0 mm) without surface defects. Multilayer coatings comprising a primer-surfacer coating provided by the present disclosure can meet aerospace performance requirements.

A primer-surfacer coating provided by the present disclosure can be prepared from a primer-surfacer precursor composition. A primer-surfacer precursor composition provided by the present disclosure can be combined with a crosslinker to provide a primer-surfacer composition that can be applied to a substrate surface, dried, and cured to provide a primer-surfacer coating. A primer-surfacer precursor composition provided by the present disclosure can comprise two parts. A first part can comprise a primer-surfacer precursor composition including a polyurethane dispersion, an acrylic copolymer dispersion, and an acrylic and/or a polyester polyol. A second part can comprise a crosslinker such as a polyaziridine, a carbodiimide, or a combination thereof. Prior to use the first part (the precursor composition) can be combined and mixed with the second part (the crosslinker) to provide a primer-surfacer composition.

A primer-surfacer precursor composition provided by the present disclosure can comprise a polyurethane dispersion. A polyurethane dispersion can comprise a water-based polyurethane dispersion. A polyurethane dispersion can comprise water and solids. The solids can comprise a polyurethane prepolymer.

A polyurethane prepolymer can have a number average molecular weight, for example, from 1,000 Daltons to 6,000 Daltons, from 1,000 Daltons to 5,000 Daltons, from 2,000 Daltons to 5,000 Daltons, or from 2,000 Daltons to 4,000 Daltons. A polyurethane prepolymer can have a number average molecular weight greater than 1,00 Daltons, greater than 2,000 Daltons, greater than 3,000 Daltons, or greater than 4,000 Daltons. A polyurethane prepolymer can have a number average molecular weight less than 6,000 Daltons, less than 5,000 Daltons, less than 4,000 Daltons, less than 3,000 Daltons, or less than 2,000 Daltons.

A polyurethane prepolymer comprises a carboxyl-functional polyurethane prepolymer.

A carboxyl-functional polyurethane prepolymer can have a carboxyl functionality, for example, from 1 to 5, such as 1, 2, 3, 4, or 5.

A carboxyl-functional polyurethane prepolymer can comprise, for example, the reaction product of reactants comprising a polyol prepolymer, a carboxylic acid diol, and a diisocyanate. A carboxyl-functional polyurethane prepolymer can comprise the reaction product of a polyol prepolymer such as a diol prepolymer and a polyisocyanate such as a diisocyanate.

A polyol prepolymer can have a number average molecular weight, for example, from 500 Daltons to 4,000 Daltons, from 300 Daltons to 3,000 Daltons, from 500 Daltons to 4,000 Daltons, or from 1,000 Daltons to 3,000 Daltons. A polyol prepolymer can have a number average molecular weight, for example, greater than 500 Daltons, greater than 1,000 Daltons, greater than 2,000 Daltons, greater than 3,000 Daltons, or greater than 4,000 Daltons. A polyol prepolymer can have a number average molecular weight, for example, less than 4,000 Daltons, less than 3,000 Daltons, less than 2,000 Daltons, or less than 1,000 Daltons.

A polyol prepolymer can have an average hydroxyl functionality, for example, from 2 to 6, from 2 to 5, from 2 to 4, or from 2 to 3. A polyol prepolymer can have an average hydroxyl functionality, for example, of 2, 3, 4, 5, or 6.

A polyol prepolymer can comprise a diol.

A polyol prepolymer can comprise, for example, a polycarbonate prepolymer.

Polycarbonate prepolymers can impart adhesion to low energy surfaces, chemical resistance, weatherability, UV resistance, abrasion resistance, and/or hardness to coating.

Examples of suitable polycarbonate diols include Eternacoll® polycarbonate diols from UBE Industries, Ltd, and Duranol® polycarbonate diols from Asahi Kasei Chemicals Corporation.

A suitable polycarbonate diol can have, for example, a number average molecular weight from 500 Daltons to 3,000 Daltons, such as from 1,000 Daltons to 2,500 Daltons, an OH value from 40 mg KOH/g to 300 mg KOH/g such as from 100 mg KOH/g to 200 mg KOH/g; a viscosity from 400 mPa×sec (at 50° C.) to 20,000 mPa×sec (at 50° C.) such as from 1,000 mPa×sec (at 50° C.) to 5,000 mPa×sec (at 50° C.); and a melting point from 4° C. to 60° C., where is determined using a Brookfield LVT viscometer with No. 3 spindle and 60 revolutions per minute (RPM) at 20° C.

Examples of suitable carboxylic acid diols include 3-hydroxy-2-(hydroxymethyl)-2-methylpropanoic acid.

A diioscyanate can comprise a flexible diisocyanate such as an aliphatic diisocyanate.

Examples of suitable aliphatic diisocyanates include Examples of suitable flexible aliphatic diisocyanates include 1,6-hexamethylene diisocyanate, 1,5-diisocyanato-2-methylpentane, 1,6-diisocyanato-2,2,4-trimethylhexane, 1,6-diisocyanato-2,4,4-trimethylhexane, 1,4-diisocyanatobutanone, tri-methyl-hexamethylene diisocyanate, 1,8-diisocyanatooctane, 1,12-diisocyanatododecane, 1,8-diisocyanto-2,4-dimethyloctane, and trimethylxylene diisocyanate (TMXDI). In (TMXDI), the isocyanate is not bonded directly to the aromatic ring.

Suitable diisocyanates also include diisocyanates having a single aromatic or cycloaliphatic ring such as isophorone diisocyanate (IPDI), 1,3-bis(isocyanato methyl)cyclohexane, 1,4-bis(isocyanato methyl)cyclohexane, trans-1,4-cyclohexylene diisocyanate, and 2,4-diisocyanato-1-methyl cyclohexane.

Suitable aliphatic diisocyanates for preparing polyurethane prepolymers include, for example, isophorone diisocyanate (IPDI), tetramethyl xylene diisocyanate (TMXDI), 4,4′-methylene dicyclohexyl diisocyanate (H₁₂MDI), 1,6-hexamethylene diisocyanate (HDI), pentane, 1,5-diisocyanato-, and a combination of any of the foregoing.

Examples of other suitable aliphatic diisocyanates also include 1,5-diisocyanato-2-methylpentane, methyl-2,6-diisocyanatohexanoate, bis(isocyanatomethyl)cyclohexane, 1,3-bis(isocyanatomethyl)cyclohexane, 2,2,4-trimethylhexane 1,6-diisocyanate, 2,4,4-trimethylhexane 1,6-diisocyanate, 2,5 (6)-bis(isocyanatomethyl)cyclo[2.2.1.]heptane, 1,3,3-trimethyl-1-(isocyanatomethyl)-5-isocyanatocyclohexane, 1,8-diisocyanato-2,4-dimethyloctane, octahydro-4,7-methano-1H-indenedimethyl diisocyanate, and 1,1′-methylenebis(4-isocyanatocyclohexane).

Examples of suitable alicyclic aliphatic diisocyanates include isophorone diisocyanate (IPDI), 1,4-cyclohexyl diisocyanate (CHDI), methylcyclohexane diisocyanate, bis(isocyanatomethyl) cyclohexane, bis(isocyanatocyclohexyl) methane, bis(isocyanatocyclohexyl)-2,2-propane, bis(isocyanatocyclohexyl)-1,2-ethane, 2-isocyanatomethyl-3-(3-isocyanatopropyl)-5-isocyanatomethyl-bicyclo[2.2.1]-heptane, 2-isocyanatomethyl-3-(3-isocyanatopropyl)-6-isocyanatomethyl-bicyclo[2.2.1]-heptane, 2-isocyanatomethyl-2-(3-isocyanatopropyl)-5-isocyanatomethyl-bicyclo[2.2.1]-heptane, 2-isocyanatomethyl-2-(3-isocyanatopropyl)-6-isocyanatomethyl-bicyclo[2.2.1]-heptane, 2-isocyanatomethyl-3-(3-isocyanatopropyl)-6-(2-isocyanatoethyl)-bicyclo[2.2.1]-heptane, 2-isocyanatomethyl-2-(3-isocyanatopropyl)-5-(2-isocyanatoethyl)-bicyclo[2.2.1]-heptane, and 2-isocyanatomethyl-2-(3-isocyanatopropyl)-6-(2-isocyanatoethyl)-bicyclo[2.2.1]-heptane.

A polyurethane dispersion provide by the present disclosure can comprise micelles comprising a carboxyl-functional polyisocyanate prepolymer such as a carboxyl-functional polycarbonate polyisocyanate prepolymer.

A polyurethane dispersion can comprise a self-crosslinking polyurethane dispersion. A self-crosslinking polyurethane dispersion can comprise a polyamine crosslinker.

A polyurethane dispersion can further comprise a polyamine such as a diamine. A polyamine can diffuse into a micelle and react with the polyisocyanate to form an amine-extended carboxyl-functional polyisocyanate polyurethane prepolymer as shown in the following reaction scheme.

A carboxyl-functional polyurethane prepolymer can comprise an amine-extended carboxyl-functional polyisocyanate polyurethane prepolymer.

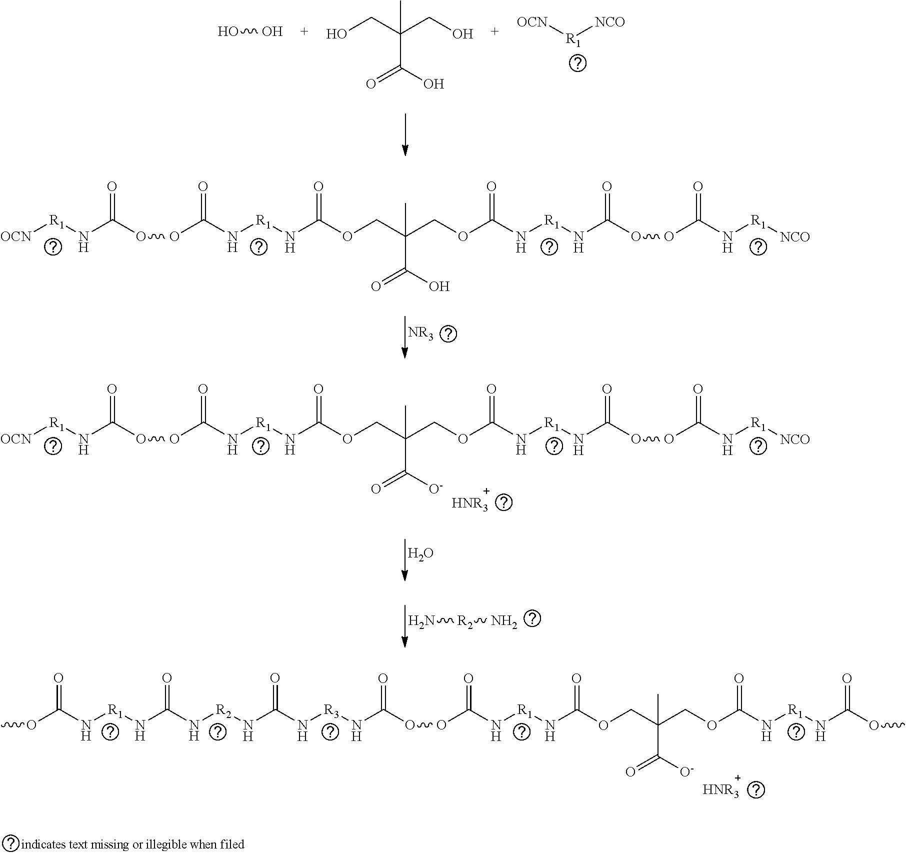

A polyamine can comprise a diamine.

Examples of suitable diamines include bis(2-dimethylamino-ethyl) ether, N,N-dimethylamino-propylamine, N,N-dimethyl cyclohexylamine, 1,8-diazabicyclo[5.4.0]undec-7-ene, N′-[3-(dimethylamino) propyl]-N,N-dimethylpropane-1,3-diamine, N,N-bis[3-(dimethylamino) propyl]-N′,N′-dimethylpropane-1,3-diamine, hydrazine hydrate, ethylene diamine, diethylene triamine, 2-methyl pentamethylene diamine, and combinations of any of the foregoing.

An amine-extended carboxyl-functional prepolymer can have a number average molecular weight, for example, from 50,000 Daltons to 600,000 Daltons, from 50,000 Daltons to 500,000 Daltons, or from 50,000 Daltons to 300,000 Daltons. A carboxyl-functional polyurethane prepolymer can have a number average molecular weight, for example, greater than 50,000 Daltons, greater than 100,000 Daltons, greater than 200,000 Daltons, or greater than 300,000 Daltons. An amine-extended carboxyl-functional prepolymer can have a number average molecular weight, for example, less than 600,000 Daltons, less than 500,000 Daltons, less than 400,000 Daltons, less than 300,000 Daltons, less than 200,000 Daltons, or less than 100,000 Daltons.

A carboxyl-functional polyurethane prepolymer can have an acid number from 10 mgKOH/gm to 30 mgKOH/gm, an NCO number from 1 to 4 such as from 1 to 3; and a NCO/OH ratio greater than 1

Examples of suitable carboxy-functional polyurethane dispersions include Daotan® TW 6490/35WA, Daotan® TW6450/30WA, and combinations of any of the foregoing.

A polyurethane dispersion can comprise, for example, from 20 wt % to 50 wt % solids, from 25 wt % to 45 wt % solids, from 30 wt % to 40 wt % solids, or from 32 wt % to 38 wt % solids, where wt % is based on the total weight of the water-based polyurethane dispersion. A water-based polyurethane dispersion can comprise, for example, greater than 20 wt % solids, greater than 25 wt %, greater than 30 wt %, greater than 35 wt %, or greater than 40 wt % solids, where wt % is based on the total weight of the water-based polyurethane dispersion. A water-based polyurethane dispersion can comprise, for example, less than 50 wt % solids, less than 45 wt % solids, less than 40 wt %, less than 35 wt %, or less than 30 wt % solids, where wt % is based on the total weight of the water-based polyurethane dispersion.

A polyurethane dispersion can comprise, for example, from 50 wt % to 80 wt % water, from 55 wt % to 75 wt % water, from 60 wt % to 70 wt %, or from 62 wt % to 68 wt % water, where wt % is based on the total weight of the polyurethane dispersion. A water-based polyurethane dispersion can comprise, for example, greater than 50 wt %, greater than 55 wt % water, greater than 60 wt % water, greater than 65 wt % water, or greater than 70 wt % water, where wt % is based on the total weight of the polyurethane dispersion. A polyurethane dispersion can comprise, for example, less than 80 wt % water, less than 70 wt % water, less than 65 wt % water, less than 60 wt % water, or less than 55 wt % water, where wt % is based on the total weight of the polyurethane dispersion.

A polyurethane dispersion can comprise, for example, from 25 wt % to 45 wt % water, from 27 wt % to 43 wt % water, or from 30 wt % to 40 wt % water, where wt % is based on the total weight of the polyurethane dispersion. A polyurethane dispersion can comprise, for example, greater than 25 wt % water, greater than 30 wt % water, greater than 35 wt % water, or greater than 40 wt % water, where wt % is based on the total weight of the polyurethane dispersion. A polyurethane dispersion can comprise, for example, less than 45 wt % water, less than 40 wt %, less than 35 wt %, or less than 30 wt % water, where wt % is based on the total weight of the polyurethane dispersion.

A primer-surfacer precursor composition provided by the present disclosure can comprise, for example, from 30 wt % to 70 wt % of a polyurethane dispersion, from 35 wt % to 65 wt %, from 40 wt % to 60 wt %, or from 45 wt % to 55 wt % of a polyurethane dispersion, where wt % is based on the total weight of the primer-surfacer precursor composition. A primer-surfacer precursor composition provided by the present disclosure can comprise, for example, greater than 30 wt % of a polyurethane dispersion, greater than 40 wt %, greater than 50 wt %, or greater than 60 wt % of a polyurethane dispersion, where wt % is based on the total weight of the primer-surfacer precursor composition. A primer-surfacer precursor composition provided by the present disclosure can comprise, for example, less than 70 wt % of a polyurethane dispersion, less than 60 wt %, less than 50 wt %, or less than 40 wt % of a polyurethane dispersion, where wt % is based on the total weight of the primer-surfacer precursor composition.

A primer-surfacer precursor composition provided by the present disclosure can comprise an acrylic copolymer dispersion. An acrylic copolymer dispersion can comprise a water-based acrylic copolymer dispersion. An acrylic copolymer dispersion can comprise water and solids. The solids can comprise an acrylic copolymer.

An acrylic copolymer refers to prepolymers prepared from acrylate monomers.

An acrylic copolymer can have a number average molecular weight, for example, from 5,000 Daltons to 15,000 Daltons.

An acrylic copolymer can be a carboxyl-functional acrylic copolymer.

A carboxyl-functional acrylic copolymer can have a carboxyl functionality, for example, from 1 to 10.

An acrylic copolymer can comprise an acrylic copolymer. For example, an acrylic copolymer can comprise, for example, an ethylene-ethyl acrylate copolymer or an ethylene-butyl acrylate copolymer.

An acrylic copolymer can have a number average molecular weight, for example, from 50,000 Daltons to 250,000 Daltons, such as from 100,000 Daltons to 200,000 Daltons.

An acrylic copolymer can impart adhesion to low energy surfaces and flexibility to a coating.

Examples of suitable carboxyl-functional acrylic copolymers include Setaqua® 6754, Setaqua® 6766, and combinations of any of the foregoing.

An acrylic copolymer dispersion can comprise a self-crosslinking copolymer dispersion. A self-crosslinking copolymer dispersion can comprise an azide crosslinker.

A water-based acrylic copolymer dispersion can comprise, for example, from 25 wt % to 55 wt % solids, from 30 wt % to 50 wt %, or from 35 wt % to 45 wt % solids, where wt % is based on the total weight of the water-based acrylic copolymer dispersion. A water-based acrylic copolymer can comprise, for example, greater than 25 wt % solids, greater than 30 wt % solids, greater than 35 wt % solids, greater than 40 wt % solids, or greater than 45 wt % solids, where wt % is based on the total weight of the water-based acrylic copolymer dispersion. A water-based acrylic copolymer can comprise, for example, less than 55 wt % solids, less than 50 wt %, less than 45 wt %, less than 40 wt %, less than 35 wt %, or less than 30 wt % solids, where wt % is based on the total weight of the water-based acrylic copolymer dispersion.

A water-based acrylic copolymer dispersion can comprise, for example, from 45 wt % to 75 wt % water, from 50 wt % to 70 wt %, or from 55 wt % to 65 wt % water, where wt % is based on the total weight of the water-based acrylic copolymer dispersion. A water-based acrylic copolymer dispersion can comprise, for example, greater than 45 wt % water, greater than 55 wt %, or greater than 65 wt % water, where wt % is based on the total weight of the water-based acrylic copolymer dispersion. A water-based acrylic copolymer dispersion can comprise, for example, less than 75 wt % water, less than 65 wt %, or less than 55 wt % water, where wt % is based on the total weight of the water-based acrylic copolymer dispersion.

An acrylic copolymer dispersion can comprise, for example, from 55 wt % to 75 wt % water, from 60 wt % to 70 wt % water, or from 62 wt % to 68 wt % water, where wt % is based on the total weight of the acrylic copolymer dispersion. An acrylic copolymer dispersion can comprise, for example, greater than 55 wt % water, greater than 60 wt % water, greater than 65 wt % water, or greater than 70 wt % water, where wt % is based on the total weight of the acrylic copolymer dispersion. An acrylic copolymer dispersion can comprise, for example, less than 75 wt % water, less than 70 wt %, less than 65 wt %, or less than 60 wt % water, where wt % is based on the total weight of the acrylic copolymer dispersion.

An acrylic copolymer dispersion can comprise, for example, from 30 wt % to 50 wt % acrylic polymer, from 35 wt % to 45 wt %, or from 37 wt % to 43 wt % acrylic copolymer, where wt % is based on the total weight of the acrylic copolymer dispersion. An acrylic copolymer dispersion can comprise, for example, greater than 30 wt % acrylic copolymer, greater than 35 wt %, greater than 40 wt %, or greater than 45 wt % acrylic copolymer, where wt % is based on the total weight of the acrylic copolymer dispersion. An acrylic copolymer dispersion can comprise, for example, less than 50 wt % acrylic copolymer, less than 45 wt %, less than 40 wt %, or less than 35 wt %, of an acrylic copolymer, where wt % is based on the total weight of the acrylic copolymer dispersion.

A primer-surfacer precursor composition provided by the present disclosure can comprise, for example, from 30 wt % to 70 wt % of an acrylic copolymer dispersion, from 35 wt % to 65 wt %, from 40 wt % to 60 wt %, or from 45 wt % to 55 wt % of an acrylic copolymer dispersion, where wt % is based on the total weight of the primer-surfacer precursor composition. A primer-surfacer precursor composition provided by the present disclosure can comprise, for example, greater than 30 wt % of an acrylic copolymer dispersion, greater than 40 wt %, greater than 50 wt %, or greater than 60 wt % of an acrylic copolymer dispersion, where wt % is based on the total weight of the primer-surfacer precursor composition. A primer-surfacer precursor composition provided by the present disclosure can comprise, for example, less than 70 wt % of an acrylic copolymer dispersion, less than 60 wt %, less than 50 wt %, or less than 40 wt % of an acrylic copolymer dispersion, where wt % is based on the total weight of the primer-surfacer precursor composition.

A primer-surfacer precursor composition provided by the present disclosure can comprise, for example, a weight ratio of a polyurethane dispersion to an acrylic copolymer dispersion, for example, from 0.7 to 1.5, from 0.8 to 1.2, or from 0.9 to 1.1.

A primer-surfacer precursor composition can comprise, for example, from 40 wt % to 60 wt % of a polyurethane polymer dispersion; and from 40 wt % to 60 wt % of an acrylic copolymer dispersion, where wt % is based on the total weight of the polyurethane polymer dispersion and the acrylic copolymer dispersion. A primer-surfacer precursor composition can comprise, for example, from 45 wt % to 55 wt % of a polyurethane prepolymer dispersion; and from 45 wt % to 55 wt % of an acrylic copolymer dispersion, where wt % is based on the total weight of the polyurethane polymer dispersion and the acrylic copolymer dispersion.

A primer-surfacer precursor composition provided by the present disclosure can comprise, for example, a weight ratio of a carboxyl-functional polyurethane prepolymer to a carboxyl-functional acrylic copolymer, for example, from 1.15 to 2.15, from 1.45 to 1.85, or from 1.55 to 1.75.

A primer-surfacer precursor composition provided by the present disclosure can comprise, for example, from 15 wt % to 45 wt % solvent, from 20 wt % to 40 wt %, or from 25 wt % to 35 wt % solvent, where wt % is based on the total weight of the primer-surfacer precursor composition. A primer-surfacer precursor composition provided by the present disclosure can comprise, for example, less than 45 wt % solvent, less than 40 wt %, less than 35 wt %, or less than 30 wt % solvent, where wt % is based on the total weight of the primer-surfacer precursor composition.

A primer-surfacer precursor composition provided by the present disclosure can comprise, for example, from 10 wt % to 40 wt % water, from 15 wt % to 35 wt %, or from 20 wt % to 30 wt % water, where wt % is based on the total weight of the primer-surfacer precursor composition. A primer-surfacer precursor composition provided by the present disclosure can comprise, for example, less than 40 wt % water, less than 35 wt %, less than 30 wt %, or less than 25 wt % water, where wt % is based on the total weight of the primer-surfacer precursor composition.

A primer-surfacer composition can comprise, for example, less than 10 wt % organic solvent, less than 8 wt %, less than 6 wt %, less than 4 wt %, or less than 2 wt % organic solvent, where wt % is based on the total weight of the primer-surfacer precursor composition.

A primer-surfacer precursor composition provided by the present disclosure can comprise a low molecular weight prepolymer or a combination of low molecular weight prepolymers.

For example, a low molecular weight prepolymer can have a number average molecular weight from 200 Daltons to 1,000 Daltons, from 300 Daltons to 900 Daltons, or from 400 Daltons to 800 Daltons. A low molecular weight prepolymer can have a number average molecular weight, for example, greater than 200 Daltons, greater than 400 Daltons, greater than 600 Daltons, or greater than 800 Daltons. A low molecular weight prepolymer can have a number average molecular weight, for example, less than 1,000 Daltons, less than 800 Daltons, less than 600 Daltons, or less than 400 Daltons.

A low molecular weight prepolymer can have functional groups reactive with isocyanate groups, acrylate groups, aziridine groups and/or carbodiimide groups For example, a low molecular weight prepolymer can comprise hydroxyl groups and/or (meth)acryloyl groups.

A low molecular weight prepolymer can have an average reactive functionality, for example, from 2 to 6, from 2 to 4, or from 2 to 3.

A low molecular weight prepolymer can impart flexibility and adhesion to a primer-surfacer coating provided by the present disclosure.

A low molecular weight prepolymer can comprise, for example, a polyester polyol such as an aliphatic polyester polyol, an acrylic, or a combination of any of the foregoing.

A primer-surfacer precursor composition provided by the present disclosure can comprise, for example, from 0.1 wt % to 20 wt % of a low molecular weight prepolymer, from 1 wt % to 15 wt %, from 1 wt % to 10 wt %, or from 1 wt % to 5 wt % of low molecular weight prepolymer, where molecular weight is based on the total weight of the primer-surfacer precursor composition. A primer-surfacer precursor composition can comprise, for example, greater than 0.1 wt %, greater than 1 wt %, greater than 5 wt % greater than 10 wt %, or greater than 15 wt % of a low molecular weight prepolymer, where wt % is based on the total weight of the primer-surfacer precursor composition. A precursor composition can comprise, for example, less than 20 wt %, less than 15 wt %, less than 10 wt %, or less than 5 wt % of a low molecular weight prepolymer, where wt % is based on the total weight of the primer-surfacer precursor composition.

A low molecular weight prepolymer can comprise, for example, a polyester polyol, an acrylic, or a combination thereof.

A primer-surfacer precursor composition provided by the present disclosure can comprise an polyester polyol or a combination of polyester polyols.

An polyester polyol can have a hydroxyl number, for example, from 130 to 330, from 150 to 310, from 170 to 290, from 190 to 270, or from 210 to 250. A polyester polyol can have a hydroxyl number, for example, greater than 130, greater than 170, greater than 210, greater than 250, or greater than 290. A polyester polyol can have a hydroxyl number, for example, less than 330, less than 290, less than 250, less than 210, or less than 170.

An polyester polyol can have a hydroxyl equivalent weight, for example, from 200 to 300, from 210 to 290, from 220 to 280, from 230 to 270, or from 240 to 260. A polyester polyol can have a hydroxyl equivalent weight, for example, greater than 200, greater than 220, greater than 240, greater than 260, or greater than 280. A polyester polyol can have a hydroxyl equivalent weight, for example, less than 300, less than 280, less than 260, less than 240, or less than 220.

A polyester polyol can have a number average molecular weight, for example, from 300 Daltons to 1,000 Daltons, from 400 Daltons to 900 Daltons, or from 500 Daltons to 800 Daltons.

A polyester polyol can have an average hydroxyl functionality, for example, from 2 to 6, from 2 to 5, from 2 to 4, or from 2 to 3. A polyester polyol can have an average hydroxyl functionality, for example, of 2, 3, 4, 5, or 6.

A polyester polyol can comprise an aliphatic polyester polyol.

A aliphatic polyester polyol can comprise an aliphatic polyester diol.

Examples of suitable aliphatic polyester polyols include K-Flex® 188, K-Flex® XM-337, K-Flex® 148, K-Flex® XM-366, K-Flex® A308, and K-Flex® XM-332, and combinations of any of the foregoing.

Aliphatic polyester polyols can improve adhesion to a topcoat.

A primer-surfacer precursor composition provided by the present disclosure can comprise an acrylic or a combination of acrylics.

An acrylic can be provided as an acrylic dispersion such as a self-linking acrylic dispersion. An acrylic dispersion can by an aqueous-based acrylic dispersion.

An acrylic dispersion can have a solids content, for example, from 10 wt % to 30 wt % such as from 15 wt % to 2 wt % solids, where wt % is based on the total weight of the acrylic copolymer dispersion.

An acrylic dispersion can have a water content, for example, from 70 wt % to 90 wt % such as from 75 wt % to 85 wt % water, where wt % is based on the total weight of the acrylic copolymer dispersion.

An acrylic can have a number average molecular weight, for example, from 200,000 Daltons to 500,000 Daltons.

An acrylic can be can comprise diacetyl acrylamide in the backbone and acryloyl groups. An acrylic dispersion can comprise adipic acid or dihydrazide crosslinkers.

Examples of suitable acrylic dispersions include Joncryl® 2981, self-crosslinking acrylic dispersion, available from BASF.

Acrylic copolymers can improve adhesion to a topcoat.

A primer-surfacer precursor composition provided by the present disclosure can comprise, for example, a rheology modifier, a fire retardant, a filler, a solvent, a colorant, a thickener, a dispersant, a reactive diluent, a leveling agent, or a combination of any of the foregoing.

A primer-surfacer precursor composition provided by the present disclosure can comprise a rheology modifier or a combination of rheology modifiers.

A rheology modifier can be included in a primer-surfacer precursor composition to adjust the viscosity of the primer-surfacer composition and to facilitate application and to build a high film thickness. A rheology modifier can minimize settling of the particulates in a composition and can minimize sagging of an applied composition.

Examples of suitable rheology modifiers include cellulose ethers such as hydroxyethyl cellulose, alkali soluble emulsions, hydrophobically-modified alkali soluble emulsions, hydrophobically-modified ethylene oxide-based urethane, bentonite clay, smectite clay, and combinations of any of the foregoing.

Examples of suitable rheology modifiers include Rheolate® 288 (Elementis).

A rheology modifier can comprise microfibrillated cellulose.

Examples of suitable cellulose include Exilva® F 01-V, Sappi Valida S191C, and combinations of any of the foregoing.

A rheology modifier can comprise a polyether polyurethane associated thickener such as Rheolate® 288.

A primer-surfacer precursor composition provided by the present disclosure can comprise, for example, from 0.5 wt % to 7.5 wt % of a rheology modifier, from 1 wt % to 7 wt %, from 1 wt % to 6 wt %, from 2 wt % to 5 wt %, or from 3 wt % to 4 wt % of a rheology modifier, where wt % is based on the total weight of the primer-surfacer precursor composition. A primer-surfacer precursor composition provided by the present disclosure can comprise, for example, greater than 0.5 wt %, greater than 1 wt %, greater than 2 wt %, greater than 3 wt %, greater than 4 wt %, or greater than 5 wt % of a rheology modifier, where wt % is based on the total weight of the primer-surfacer precursor composition. A primer-surfacer precursor composition provided by the present disclosure can comprise, for example, less than 7.5 wt % of a rheology modifier, less than 6 wt %, less than 4 wt %, or less than 2 wt % of a rheology modifier, where wt % is based on the total weight of the primer-surfacer precursor composition.

A primer-surfacer precursor composition provided by the present disclosure can comprise a fire retardant or a combination of fire retardants.

A fire retardant can include an inorganic fire retardant, an organic fire retardant, or a combination thereof.

Examples of suitable inorganic fire retardants include aluminum hydroxide, magnesium hydroxide, zinc borate, antimony oxides, hydromagnesite, aluminum trihydrate (ATH), calcium phosphate, titanium oxide, zinc oxide, magnesium carbonate, barium sulfate, barium borate, kaolinite, silica, antimony oxides, and combinations of any of the foregoing.

Examples of suitable organic fire retardants include halocarbons, halogenated esters, halogenated ethers, chlorinated and/or brominated flame retardants, halogen free compounds such as organophosphorus compounds, organonitrogen compounds, and combinations of any of the foregoing.

A fire retardant can comprise, for example, aluminum trihydrate.

A primer-surfacer precursor composition provided by the present disclosure can comprise, for example, from 2 wt % to 12 wt % of a fire retardant, from 3 wt % to 11 wt %, from 4 wt % to 10 wt %, from 5 wt % to 9 wt %, or from 6 wt % to 8 wt % of a fire retardant, where wt % is based on the total weight of the primer-surfacer precursor composition. A primer-surfacer precursor composition provided by the present disclosure can comprise, for example, greater than 2 wt %, greater than 4 wt %, greater than 6 wt %, greater than 8 wt %, or greater than 10 wt % of a fire retardant, where wt % is based on the total weight of the primer-surfacer precursor composition. A primer-surfacer precursor composition provided by the present disclosure can comprise, for example, less than 12 wt %, less than 10 wt %, less than 8 wt %, less than 6 wt %, or less than 4 wt % of a fire retardant, where wt % is based on the total weight of the primer-surfacer precursor composition.

A primer-surfacer precursor composition provided by the present disclosure can comprise a filler or a combination of filler.

A filler can comprise, for example, inorganic filler, organic filler, low-density filler, conductive filler, or a combination of any of the foregoing.

A primer-surfacer precursor composition provided by the present disclosure can comprise, for example, from 0 wt % to 30 wt % filler, from 5 wt % to 25 wt % filler, from 7 wt % to 23 wt %, from 9 wt % to 21 wt %, from 11 wt % to 19 wt %, or from 13 wt % to 17 wt % filler, where wt % is based on the total weight of the primer-surfacer precursor composition. A primer-surfacer precursor composition provided by the present disclosure can comprise, for example, greater than 0 wt % filler, greater than 5 wt %, greater than 10 wt %, greater than 15 wt %, greater than 20 wt %, or greater than 25 wt % filler, where wt % is based on the total weight of the primer-surfacer precursor composition. A primer-surfacer precursor composition provided by the present disclosure can comprise, for example, less than 30 wt % filler, less than 25 wt %, less than 20 wt %, less than 15 wt %, less than 10 wt %, or less than 5 wt % filler, where wt % is based on the total weight of the primer-surfacer precursor composition.

A primer-surfacer precursor composition provided by the present disclosure can comprise an inorganic filler or combination of inorganic filler.

An inorganic filler can be included to provide mechanical reinforcement and to control the rheological properties of the composition. Inorganic filler may be added to compositions to impart desirable physical properties such as, for example, to increase the impact strength, to control the viscosity, or to modify the electrical properties of a cured composition.

Inorganic filler useful in compositions can include carbon black, calcium carbonate, precipitated calcium carbonate, calcium hydroxide, hydrated alumina (aluminum hydroxide), talc, mica, titanium dioxide, alumina silicate, carbonates, chalk, silicates, glass, metal oxides, graphite, silica and combinations of any of the foregoing.

Examples of suitable silica include silica gel/amorphous silica, precipitated silica, fumed silica, and treated silica such as polydimethylsiloxane-treated silica. A primer-surfacer precursor composition provided by the present disclosure can comprise silica gel or combination of silica gel. Suitable silica gel includes Gasil® silica gel available from PQ Corporation, and Sylysia®, CariAct® and Sylomask® silica gel available from Fuji Silysia Chemical Ltd.

Suitable calcium carbonate filler includes products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

A primer-surfacer precursor composition provided by the present disclosure can comprise a filler comprising combination of silica and calcium carbonate.

Inorganic filler can be surface treated to provide hydrophobic or hydrophilic surfaces that can facilitate dispersion and/or compatibility of the inorganic filler with other components of a primer-surfacer precursor composition. An inorganic filler can include surface-modified particles such as, for example, surface modified silica. The surface of silica particles can be modified, for example, to be tailor the hydrophobicity or hydrophilicity of the surface of the silica particle. The surface modification can affect the dispensability of the particles, the viscosity, the curing rate, and/or the adhesion.

A primer-surfacer precursor composition can comprise, for example, from 10 wt % to 40 wt % of an inorganic filler, from 15 wt % to 35 wt %, or from 20 wt % to 30 wt % or an inorganic filler, where wt % is based on the total weight of the primer-surfacer precursor composition. A primer-surfacer composition provided by the present disclosure can comprise, for example, greater than 10 wt % of an inorganic filler, greater than 15 wt %, greater than 20 wt %, greater than 25 wt %, greater than 30 wt %, or greater than 35 wt % of an inorganic filler, where wt % is based on the total weight of the primer-surfacer precursor composition. A primer-surfacer composition provided by the present disclosure can comprise, for example, less than 40 wt % of an inorganic filler, less than 35 wt %, less than 30 wt %, less than 25 wt %, less than 20 wt %, or less than 15 wt % of an inorganic filler, where wt % is based on the total weight of the primer-surfacer precursor composition.

A primer-surfacer precursor composition provided by the present disclosure can comprise an organic filler or a combination of organic filler.

Organic filler can be selected to have a low specific gravity and to be resistant to solvents such as JRF Type I and/or to reduce the density of a coating layer. Suitable organic filler can also have acceptable adhesion to the sulfur-containing polymer matrix. An organic filler can include solid powders or particles, hollow powders or particles, or a combination thereof.

An organic filler can have a specific gravity, for example, less than 1.15, less than 1.1, less than 1.05, less than 1, less than 0.95, less than 0.9, less than 0.8, or less than 0.7. Organic filler can have a specific gravity, for example, within a range from 0.85 to 1.15, within a range from 0.9 to 1.1, within a range from 0.9 to 1.05, or from 0.85 to 1.05.

Organic filler can comprise a thermoplastic, a thermoset, or a combination thereof. Examples of suitable thermoplastics and thermosets include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Examples of suitable polyamide 6 and polyamide 12 particles are available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can include a polyethylene powder, such as an oxidized polyethylene powder. Suitable polyethylene powders are available from Honeywell International, Inc. under the tradename ACumist®, from INEOS under the tradename Eltrex®, and Mitsui Chemicals America, Inc. under the tradename Mipelon®.

The use of organic filler such as polyphenylene sulfide in aerospace sealants is disclosed in U.S. Pat. No. 9,422,451. Polyphenylene sulfide is a thermoplastic engineering resin that exhibits dimensional stability, chemical resistance, and resistance to corrosive and high temperature environments. Polyphenylene sulfide engineering resins are commercially available, for example, under the tradenames Ryton® (Chevron), Techtron® (Quadrant), Fortron® (Celanese), and Torelina® (Toray). Polyphenylene sulfide resins are generally characterized by a specific gravity from about 1.3 to about 1.4.

A primer-surfacer precursor composition provided by the present disclosure can comprise a soft filler or combination of soft filler.

A soft filler can facilitate smoothing the surface of a cured primer-surfacer coating by mechanical abrasion.

A soft filler refers to a filler having hardness, for example, of less than 2.5 Mohs, less than 2.0 Mohs, or less than 1.5 Mohs.

Examples of soft filler include come carbon black, kaolin, talc, gypsum, and combinations of any of the foregoing.

A primer-surfacer precursor composition provided by the present disclosure can comprise a low density filler or a combination of low-density filler.

An organic filler can include a low density such as a modified, expanded thermoplastic microcapsules. Suitable modified expanded thermoplastic microcapsules can include an exterior coating of a melamine or urea/formaldehyde resin.

A primer-surfacer precursor composition can comprise low density microcapsules. A low-density microcapsule can comprise a thermally expandable microcapsule.

Examples of suitable thermoplastic microcapsules include Expancel® microcapsules such as Expancel® DE microspheres available from AkzoNobel. Examples of suitable Expancel® DE microspheres include Expancel® 920 DE 40 and Expancel® 920 DE 80. Suitable low-density microcapsules are also available from Kureha Corporation.

Low density filler such as low density thermally expanded microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low density filler such as low microcapsules can be characterized by a mean particle diameter from 1 μm to 100 μm and can have a substantially spherical shape. Low density filler such as low-density microcapsules can be characterized, for example, by a mean particle diameter from 10 μm to 100 μm, from 10 μm to 60 μm, from 10 μm to 40 μm, or from 10 μm to 30 μm, as determined according to ASTM D1475.

A low-density filler can comprise glass microspheres. For example, glass microspheres can have a bulk density, for example, form 0.1 g/cc to 0.5 g/cc and a particle size, for example, from 5 μm to 100 μm such as from 10 μm to 89 μm. Examples of suitable glass microspheres include glass bubbles available from 3M™ and hollow glass microspheres available from Potters Industries.

Low density filler such as low-density microcapsules can comprise expanded microcapsules or microballoons having a coating of an aminoplast resin such as a melamine resin. Aminoplast resin-coated particles are described, for example, in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the particle.

A primer-surfacer precursor composition can comprise, for example, from 0 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total weight of the composition.

A primer-surfacer precursor composition can comprise greater than 0 wt % low density filler, greater than 1 wt %, greater than 2 wt %, greater than 3 wt %, greater than 4 wt %, greater than 1 wt %, or greater than 10 wt % low-density filler, where wt % is based on the total weight of the primer-surfacer precursor composition.

A primer-surfacer precursor composition can comprise from 0 vol % to 90 vol % low-density filler, from 5 vol % to 70 vol %, from 10 vol % to 60 vol %, from 20 vol % to 50 vol %, or from 30 vol % to 40 vol % low density filler, where vol % is based on the total volume of the primer-surfacer precursor composition.

A primer-surfacer precursor composition can comprise greater than 1 vol % low-density filler, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total volume of the primer-surfacer precursor composition.

A primer-surfacer precursor composition provided by the present disclosure can comprise an organic solvent or a combination of organic solvents.

An organic solvent can facilitate film formation.

Examples of suitable organic solvents include, glycol ether, dimethoxy propanol, propylene glycol monomethyl ether, dipropylene glycol monomethyl ether, or a combination of any of the foregoing.

A primer-surfacer precursor composition provided by the present disclosure can comprise, for example, from 0 wt % to 15 wt % organic solvent, from 1 wt % to 13 wt %, from 2 wt % to 10 wt %, from 3 wt % to 9 wt %, from 4 wt % to 8 wt %, or from 5 wt % to 7 wt % of an organic solvent, where wt % is based on the total weight of the primer-surfacer precursor composition. A primer-surfacer precursor composition provided by the present disclosure can comprise, for example, greater than 0 wt % organic solvent, greater than 2 wt %, greater than 4 wt %, greater than 6 wt %, greater than 8 wt %, greater than 10 wt %, or greater than 12 wt % organic solvent, where wt % is based on the total weight of the precursor composition. A primer-surfacer precursor composition provided by the present disclosure can comprise, for example, less than 15 wt %, less than 12 wt %, less than 10 wt %, less than 8 wt %, less than 6 wt %, less than 4 wt %, or less than 2 wt % organic solvent, where wt % is based on the total weight of the primer-surfacer precursor composition.

A primer-surfacer precursor composition provided by the present disclosure can comprise one or more colorants.

A primer-surfacer precursor composition provided by the present disclosure can comprise a pigment, a dye, a photochromic agent, or a combination of any of the foregoing.

Any suitable dye, pigment, and/or photochromic agent can be used.

Examples of suitable inorganic pigments include metal-containing inorganic pigments such as those containing cadmium, carbon, chromium, cobalt, copper, iron oxide, lead, mercury, titanium, tungsten, and zinc. Examples include ultramarine blue, ultramarine violet, reduced tungsten oxide, cobalt aluminate, cobalt phosphate, manganese ammonium pyrophosphate and/or metal-free inorganic pigments. In particular embodiments the inorganic pigment nanoparticles comprise ultramarine blue, ultramarine violet, Prussian blue, cobalt blue and/or reduced tungsten oxide. Examples of specific organic pigments include indanthrone, quinacridone, phthalocyanine blue, copper phthalocyanine blue, and perylene anthraquinone.

Additional examples of suitable pigments include iron oxide pigments, in all shades of yellow, brown, red and black; in all their physical forms and grain categories; titanium oxide pigments in all the different inorganic surface treatments; chromium oxide pigments also co-precipitated with nickel and nickel titanates; black pigments from organic combustion (e.g., carbon black); blue and green pigments derived from copper phthalocyanine, also chlorinated and brominated, in the various alpha, beta and epsilon crystalline forms; yellow pigments derived from lead sulphochromate; yellow pigments derived from lead bismuth vanadate; orange pigments derived from lead sulphochromate molybdate; yellow pigments of an organic nature based on arylamides; orange pigments of an organic nature based on naphthol; orange pigments of an organic nature based on diketo-pyrrolo-pyrrole; red pigments based on manganese salts of azo dyes; red pigments based on manganese salts of beta-oxynaphthoic acid; red organic quinacridone pigments; and red organic anthraquinone pigments.

A primer-surfacer precursor composition can comprise, for example, titanium dioxide, carbon black, or a combination thereof.

A primer-surfacer precursor composition can comprise, for example, from 0.1 wt % to 10 wt % of a colorant, from 1 wt % to 8 wt %, from 2 wt % to 6 wt % or from 4 wt % to 6 wt % of a colorant, where wt % is based on the total weight of the primer-surfacer precursor composition. A primer-surfacer precursor composition can comprise, for example, greater than 0.1 wt %, greater than 1 wt %, greater than 2 wt %, greater than 4 wt %, greater than 6 wt %, or greater than 8 wt % of a colorant, where wt % is based on the total weight of the primer-surfacer precursor composition. A primer-surfacer precursor composition can comprise, for example, less than 10 wt % of a colorant, less than 8 wt %, less than 6 wt %, less than 4 wt %, less than 2 wt % or less than 1 wt % of a colorant, where wt % is based on the total weight of the primer-surfacer precursor composition.

A primer-surfacer precursor composition provided by the present disclosure can comprise a wetting agent/dispersant or combination of wetting agents/dispersants.

A dispersant can facilitate the suspension of particulates such as filler and pigments in the primer-surfacer precursor composition.

Examples of suitable wetting agents/dispersants include silicone-based agents, silicone-free agents such as acetylenic and alkoxylate derivatives, polymeric silicone-free agents such as acrylate or maleate derivatives, an fluoro-based agents.

A wetting agent/dispersant can be a high molecular weight block copolymer with pigment affinity groups.

A wetting agent/dispersant can comprise, for example, Disperbylk®-190 and Nuosperse® FX7500W.

A primer-surfacer precursor composition provided by the present disclosure can comprise, for example, from 0.1 wt % to 5 wt % of a wetting agent/dispersant, from 0.5 wt % to 4 wt %, or from 1 wt % to 3 wt % of a wetting agent/dispersant, where wt % is based on the total weight of the primer-surfacer precursor composition. A primer-surfacer precursor composition provided by the present disclosure can comprise, for example, greater than 0.1 wt % of a wetting agent/dispersant, greater than 0.5 wt %, greater than 1 wt %, or greater than 3 wt % of a wetting agent/dispersant, where wt % is based on the total weight of the primer-surfacer precursor composition. A primer-surfacer precursor composition can comprise, for example, less than 5 wt %, less than 3 wt %, or less than 1 wt % of a wetting agent/dispersant, where wt % is based on the total weight of the primer-surfacer precursor composition.

A primer-surfacer precursor composition provided by the present disclosure can comprise a thickener or combination of thickeners.

Examples of suitable thickeners include polyether polyurethane resin solutions such as Rheolate® 288.

A primer-surfacer precursor composition can comprise, for example, less than 2 wt % of a thickener, less than 1 wt %, or less than 0.1 wt % of a thickener, where wt % is based on the total weight of the primer-surfacer precursor composition.

A primer-surfacer precursor composition provided by the present disclosure can comprise a defoamer or a combination of defoamers.

A defoamer can minimize the incorporation of air into a composition.

Examples of suitable defoamer include silicone-based defoamers, organic-based defoamers, and molecular-based defoamers, and combinations of any of the foregoing.

A defoamer can comprise a silicone-containing compound such as BYK®-022 available from BYK Chemie.

A primer-surfacer precursor composition can comprise, for example, less than 2 wt % of a defoamer, less than 1.6 wt %, less than 1.2 wt %, or less than 0.8 wt % of a defoamer, where wt % is based on the total weight of the primer-surfacer precursor composition.

A primer-surfacer precursor composition provided by the present disclosure can comprise a leveling agent or a combination of leveling agents.

A leveling agent can facilitated the ability of a compositions to wet a surface.

Examples of suitable leveling agents include fluorochemical surfactants, polyacrylate-based surfactants and polysiloxane-based surfactants, and combinations of any of the foregoing.

A leveling agent can comprise a fluorocarbon-modified such as Hydropalat® WE 3370, available from BASF.

A primer-surfacer precursor composition can comprise, for example, less than 1 wt % of a leveling agent, less than 0.8 wt %, less than 0.6 wt %, less than 0.4 wt %, or less than 0.2 wt % of a leveling agent, where wt % is based on the total weight of the primer-surfacer precursor composition.

A primer-surfacer precursor composition provided by the present disclosure can comprise, for example, from 15 wt % to 45 wt % of a polyurethane such as a carboxyl-functional polyurethane, from 20 wt % to 40 wt %, or from 25 wt % to 35 wt % of a polyurethane such as a carboxyl-functional polyurethane, where wt % is based on the total weight of the primer-surfacer precursor composition. A primer-surfacer precursor composition provided by the present disclosure can comprise, for example, greater than 15 wt % of a polyurethane such as a carboxyl-functional polyurethane, greater than 20 wt %, greater than 25 wt %, greater than 30 wt %, greater than 35 wt %, or greater than 40 wt % of a polyurethane such as a carboxyl-functional polyurethane, where wt % is based on the total weight of the primer-surfacer precursor composition. A primer-surfacer precursor composition provided by the present disclosure can comprise, for example, less than 45 wt % of a polyurethane such as a carboxyl-functional polyurethane, less than 40 wt %, less than 35 wt %, less than 30 wt %, or less than 25 wt % of a polyurethane such as a carboxyl-functional polyurethane, where wt % is based on the total weight of the primer-surfacer precursor composition.

A primer-surfacer precursor composition provided by the present disclosure can comprise, for example, from 10 wt % to 30 wt % of an acrylic copolymer such as a carboxyl-functional acrylic copolymer, from 12 wt % to 28 wt %, from 15 wt % to 25 wt %, or from 17 wt % to 23 wt % of an acrylic copolymer such as a carboxyl-functional acrylic copolymer, where wt % is based on the total weight of the primer-surfacer precursor composition. A primer-surfacer precursor composition provided by the present disclosure can comprise, for example, greater than 10 wt % of an acrylic copolymer such as a carboxyl-functional acrylic copolymer, greater than 15 wt %, greater than 20 wt %, or greater than 25 wt % of an acrylic copolymer such as a carboxyl-functional acrylic copolymer, where wt % is based on the total weight of the primer-surfacer precursor composition. A primer-surfacer precursor composition provided by the present disclosure can comprise, for example, less than 30 wt % of an acrylic copolymer such as a carboxyl-functional acrylic copolymer, less than 25 wt %, less than 20 wt %, or less than 15 wt % of an acrylic copolymer such as a carboxyl-functional acrylic copolymer, where wt % is based on the total weight of the primer-surfacer precursor composition.

A primer-surfacer precursor composition provided by the present disclosure can comprise, for example, from 0.5 wt % to 6 wt % of an aliphatic polyester polyol, from 1 wt % to 5 wt %, from 1 wt % to 4 wt %, or from 1 wt % to 3 wt % of an aliphatic polyester polyol, where wt % is based on the total weight of the primer-surfacer precursor composition. A primer-surfacer precursor composition provided by the present disclosure can comprise, for example, greater than 0.5 wt % of an aliphatic polyester polyol, greater than 1 wt %, greater than 2 wt %, greater than 3 wt %, or greater than 4 wt % of an aliphatic polyester polyol, where wt % is based on the total weight of the primer-surfacer precursor composition. A primer-surfacer precursor composition provided by the present disclosure can comprise, for example, less than 6 wt % of an aliphatic polyester polyol, less than 5 wt %, less than 4 wt %, less than 3 wt %, less than 2 wt %, or less than 1 wt % of an aliphatic polyester polyol, where wt % is based on the total weight of the primer-surfacer precursor composition.

The ratio of polyurethane dispersion to acrylic dispersion in the primer-surfacer precursor composition can be about 1:1 such as from 1.2:1 to 1:1.2.

In general, the polyurethane dispersion increases the drying time and improves wet/dry adhesion to the substrate and to an overlying coating.

In general, the acrylic dispersion decreases the drying time and improves the wet/dry adhesion to the substrate and the overlying coating.

A primer-surfacer composition provided by the present disclosure can comprise, for example, from 30 wt % to 60 wt % water, from 35 wt % to 55 wt %, or from 40 wt % to 50 wt % water, where wt % is based on the total weight of the primer-surfacer precursor composition. A primer-surfacer precursor composition provided by the present disclosure can comprise, for example, greater than 30 wt % water, greater than 40 wt %, or greater than 50 wt % water, where wt % is based on the total weight of the primer-surfacer precursor composition. A primer-surfacer precursor composition provided by the present disclosure can comprise, for example, less than 60 wt % water, less than 50 wt %, or less than 40 wt % water, where wt % is based on the total weight of the primer-surfacer precursor composition.

A primer-surfacer precursor composition provided by the present disclosure can be substantially free of isocyanates. For example, a primer-surfacer precursor composition can have less than 2 mol % isocyanate functional groups, less than 1.5 mol %, less than 1 mol %, less than 0.5 mol %, less than 0.2 mol %, less than 0.1 mol %, or less than 0.05 mol % isocyanate functional groups, where mol % is based on the total moles of reactive functional groups in the primer-surfacer precursor composition. A primer-surfacer precursor composition provided by the present disclosure can have, for example, from 0.01 mol % to 2 mol %, from 0.01 mol % to 1.0 mol %, or from 0.01 mol % to 0.1 mol % isocyanate functional groups, where mol % is based on the total moles of reactive functional groups in the primer-surfacer precursor composition. Examples of reactive functional groups in a primer-surfacer precursor composition include carboxyl groups.

A primer-surfacer precursor composition provided by the present disclosure can have a volatile organic content (VOC), for example, from 0 g/L to 180 g/L, from 0 g/L to 120 g/L, from from 0 g/L to 100 g/L, from 10 g/L to 89 g/L, from 10 g/L to 60 g/L, or from 10 g/L to 40 g/L. A primer-surfacer precursor composition provided by the present disclosure can have a VOC, for example, greater than 0 g/L, greater than 20 g/L, greater than 40 g/L, greater than 60 g/L, greater than 80 g/L, greater than 100 g/L, greater than 120 g/L, or greater than 160 g/L. A primer-surfacer precursor composition provided by the present disclosure can have a VOC, for example, less than 180 g/L, less than 120 g/L, less than 100 g/L, less than 80 g/L, less than 60 g/L, less than 40 g/L, or less than 20 g/L.

A primer-surfacer precursor composition provided by the present disclosure can have a specific gravity, for example, less than 1.2, less than 1.1, less than 1.0, less than 0.9, less than 0.8, or less than 0.7, where specific gravity is determined according to ASTM D1475. A primer-surfacer precursor composition provided by the present disclosure can have a specific gravity, for example, from 0.7 to 1.2, from 0.7 to 1.1, from 0.7 to 1.0, or from 0.7 to 0.9, where specific gravity is determined according to ASTM D1475.

A primer-surfacer precursor composition provided by the present disclosure can have, for example, a VOC less than 180 g/L, such as less than 100 g/L; a specific gravity less than 1; and can be substantially free of isocyanates.

A primer-surfacer precursor composition provided by the present disclosure can have a solids content, for example, from 30 wt % to 45 wt % such as from 35 wt % to 40 wt %, and a water content, for example, from 55 wt % to 70 wt % such as from 60 wt % to 65 wt %, where wt % is based on the total weight of the primer-surfacer precursor composition.

A primer-surfacer precursor composition provided by the present disclosure can be prepared by combining and mixing a polyurethane dispersion, an acrylic dispersion, and water.

A primer-surfacer precursor composition provided by the present disclosure can comprise, for example, from 20 wt % to 40 wt % of a polyurethane dispersion such as from 25 wt % to 35 wt % of a polyurethane dispersion, where wt % is based on the total weight of the primer-surfacer precursor composition.

A primer-surfacer precursor composition provided by the present disclosure can comprise, for example, from 40 wt % to 60 wt % of an acrylic dispersion such as from 45 wt % to 55 wt % of an acrylic dispersion, wherein wt % is based on the total weight of the primer-surfacer precursor composition.

A primer-surfacer precursor composition provided by the present disclosure can comprise, for example, from 30 wt % water to 60 wt % water, such as from 35 wt % to 55 wt % water, or from 40 wt % to 50 wt % water, wherein wt % is based on the total weight of the primer-surfacer precursor composition.

A primer-surfacer precursor composition provided by the present disclosure can comprise, for example, from 40 wt % to 60 wt % of a polyurethane dispersion; and from 40 wt % to 60 wt % of an acrylic copolymer dispersion, wherein wt % is based on the total weight of the polyurethane dispersion and the acrylic copolymer dispersion. A primer-surfacer precursor composition can comprise, for example, from 45 wt % to 55 wt % of a polyurethane dispersion; and from 45 wt % to 55 wt % of an acrylic copolymer dispersion, wherein wt % is based on the total weight of the polyurethane dispersion and the acrylic copolymer dispersion.

A polyurethane dispersion can comprise an aqueous polyurethane dispersion of a carboxyl-functional polyurethane prepolymer. An aqueous polyurethane dispersion can comprise, for example, a solids content from 25 wt % to 45 wt %, and from 55 wt % to 75 wt % water, where wt % is based on the total weight of the aqueous polyurethane dispersion. An aqueous polyurethane dispersion can comprise, for example, a solids content from 30 wt % to 40 wt %, and from 60 wt % to 70 wt % water, where wt % is based on the total weight of the aqueous polyurethane dispersion.

A primer-surfacer composition provided by the present disclosure can comprise a primer-surfacer precursor composition provided by the present disclosure and a crosslinker. A primer-surfacer composition is uncured and can be applied to a substrate surface. After the applied primer-surfacer composition is dried and cured, a cured primer-surfacer coating is formed. The applied primer-surfacer composition cures as the solvents evaporate.

A primer-surfacer composition can comprise substantially the same amounts of the solid constituents of the primer-surfacer precursor composition because the amount of the crosslinker is low, such as less than 5 wt %, based on the total weight of the primer-surfacer precursor composition. By substantially the same is meant that the amount such as the wt % is within +/−10% of the nominal amount, such as within +/−5% of the nominal amount, or within +−2% of the nominal amount.

A primer-surfacer composition provided by the present disclosure can comprise a crosslinker or combination of crosslinker.

A crosslinker can comprise functional groups that are reactive with carboxyl groups.

A crosslinker can comprise a polyaziridine, a carbodiimide, or a combination thereof.

A primer-surfacer composition provided by the present disclosure can comprise, for example, from 1 wt % to 5 wt % of a crosslinker, from 1 wt % to 4 wt %, from 1 wt % to 3.5 wt %, from 1 wt % to 3 wt %, or from 1.5 wt % to 2.5 wt %, where wt % is based on the total weight of the primer-surfacer composition. A primer-surfacer composition provided by the present disclosure can comprise, for example, greater than 1 wt % of a crosslinker, greater than 2 wt %, greater than 3 wt %, or greater than 4 wt % of a crosslinker, where wt % is based on the total weight of the primer-surfacer composition. A primer-surfacer composition provided by the present disclosure can comprise, for example, less than 5 wt % of a crosslinker, less than 4 wt %, less than 3 wt %, or less than 2 wt % of a crosslinker, where wt % is based on the total weight of the primer-surfacer composition.

A crosslinker can comprise a polyaziridine or a combination of polyaziridines.

A polyaziridine can comprise a propylene imine-based polyaziridine.

A polyaziridine can comprise trimethylolpropane tris(2-methyl-1-aziridine propionate).

A polyaziridine can comprise an ethylene imine-based polyaziridine.

A polyaziridine can comprise trimethylolpropane tris(2-methyl-1-aziridine propionate).

A polyaziridine can comprise a multifunctional polymeric aziridine crosslinker, such as a low toxicity (e.g., non-genotoxic and non-mutagenic), multifunctional polymeric aziridine crosslinker for reaction with carboxylic acid functional waterborne acrylic emulsions and/or urethane dispersions.

A polyaziridine can be characterized by an average aziridine functionality, for example, from 2.1 to 6, from 2.1 to 5, from 2.1 to 4, from 2.1 to 3, or from 2.3 to 3. A polyaziridine can be characterized by an average aziridine functionality, for example, greater than 2.1, greater than 2. 3, greater than 2.5, greater than 2.7, greater than 2.9, greater than 4, or greater than 5. A polyaziridine can be characterized by an average aziridine functionally, for example, less than 6, less than 5, less than 4, less than 3, or less than 2.8, or less than 2.5.

A crosslinker can comprise a carbodiimide or a combination of carbodiimides.

Examples of suitable carbodiimides include Carbodilite® V-02-L2, Carbodilite® V-02, Carbodilite® E-09 (Nisshinbo Chemical).

A carbodiimide crosslinkers can comprise, for example, from 3 to 20, carbodiimide units per molecule such as from 4 to 8 carbodiimide units per molecule.

A carbodiimide crosslinker can be obtained for example by carbodiimidization of diisocyanates such as for example tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethyl cyclohexane, 4,4′-diisocyanatodicyclohexylmethane, 4,4′-diisocyanatodicyclohexylpropane-(2,2), 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, optionally with incorporation of monofunctional isocyanates such as for example stearyl isocyanate, phenyl isocyanate, butyl isocyanate, hexyl isocyanate or/and higher-functional isocyanates such as trimers, uretdiones, allophanates, biurets of the diisocyanates cited by way of example, with subsequent, simultaneous or preliminary reaction with hydrophilizing components, for example mono- or difunctional polyethers based on ethylene oxide polymers or ethylene oxide/propylene oxide copolymers started on alcohols or amines.

A carbodiimide crosslinker can be obtained by carbodiimidization of 1-isocyanato-3,3,5-trimethyl-5-isocyanatomethyl cyclohexane and/or 4,4′-diisocyanatodicyclohexylmethane.

A carbodiimide crosslinker such as Carbodilite® V-02-L2 is a non-ionically hydrophilized, cycloaliphatic carbodiimide, 40 wt % in water, having a carbodiimide equivalent weight of about 385.

A primer-surfacer precursor composition provided by the present disclosure can comprise a solids content comprising:
from 22 wt % to 34 wt % of a carboxyl-functional polyurethane prepolymer,
from 0.5 wt % to 1.3 wt % of a defoamer,
from 4.5 wt % to 7 wt % of a rheology modifier,
from 3 wt % to 5 wt % of a dispersant,
from 6 wt % to 10 wt % of an inorganic filler,
from 8 wt % to 13 wt % of a flame retardant,
from 6 wt % to 10 wt % of a pigment,
from 8 wt % to 18 wt % of a carboxyl-functional acrylic copolymer,
from 3 wt % to 12 wt % of an acrylic a polyester polyol, or a combination thereof;
from 10 wt % to 17 wt % of a low-density filler,
from 0.5 wt % to 1.0 wt % of a wetting/leveling agent, and
from 0.01 wt % to 0.2 wt % of a thickener,
where wt % represents the total weight of the solids in the primer-surfacer precursor composition.
A primer-surfacer precursor composition provided by the present disclosure can comprise a solids content comprising:
from 25 wt % to 31 wt % of a carboxyl-functional polyurethane prepolymer,
from 0.8 wt % to 1.1 wt % of a defoamer,
from 5 wt % to 7 wt % of a rheology modifier,
from 3.5 wt % to 4.5 wt % of a dispersant,
from 7 wt % to 9 wt % of an inorganic filler,
from 9 wt % to 12 wt % of a flame retardant,
from 7 wt % to 9 wt % of a pigment,
from 10 wt % to 16 wt % of a carboxyl-functional acrylic copolymer,
from 5 wt % to 10 wt % of
an acrylic a polyester polyol, or a combination thereof;
from 12 wt % to 15 wt % of a low-density filler,
from 0.7 wt % to 0.9 wt % of a wetting/leveling agent, and
from 0.01 wt % to 0.2 wt % of a thickener,
where wt % represents the total weight of the solids in the primer-surfacer precursor composition.

A primer-surfacer composition provided by the present disclosure can comprise the same wt % of the solid constituents as in the primer-surfacer precursor composition.

A primer-surfacer coating provided by the present disclosure can comprise the same wt % of the solid constituents as in the primer-surfacer composition and/or polymers derived from the sold constituents of the primer-surfacer composition. For example, a primer-surfacer coating can comprise the reaction product of reactants comprising the carboxyl-functional polyurethane prepolymer, the carboxyl;—functional acrylic copolymer, the flexible copolymer, and the crosslinker.

A primer-surfacer composition provided by the present disclosure is configured to cure during and/or after evaporation of the neutralizing agents, where the neutralizing agents include water and organic solvent.

A primer-surfacer composition provided by the present disclosure can have a VOC, for example, from 0 g/L to 180 g/L, from 0 g/L to 180 g/L, from 0 g/L to 120 g/L, from 0 g/L to 100 g/L from 10 g/L to 89 g/L, from 10 g/L to 60 g/L, or from 10 g/L to 40 g/L. A primer-surfacer composition provided by the present disclosure can have a VOC, for example, greater than 0 g/L, greater than 20 g/L, greater than 40 g/L, greater than 60 g/L, greater than 80 g/L, greater than 100 g/L, greater than 120 g/L, greater than 140 g/L, or greater than 160 g/L. A primer-surfacer composition provided by the present disclosure can have a VOC, for example, less than 180 g/L, less than 140 g/L, less than 120 g/L, less than 100 g/L, less than 80 g/L, less than 60 g/L, less than 40 g/L, or less than 20 g/L.

A primer-surfacer composition provided by the present disclosure can comprise a specific gravity, for example, from 0.6 to 1.1, from 0.6 to 1.0, from 0.6 to 0.9, or from 0.6 to 0.8. A primer-surfacer composition provided by the present disclosure can comprise a specific gravity, for example, greater than 0.6, greater than 0.7, greater than 0.8, greater than 0.9, greater than 1.0, or greater than 1.1. A primer-surfacer composition provided by the present disclosure can comprise a specific gravity, for example, less than 1.2, less than 1.0, less than 0.9, less than 0.8, less than 0.7, or less than 0.6.

A primer-surfacer composition provided by the present disclosure can have a pot life, for example, from 3 hours to 10 hours, from 4 hours to 8 hours, or from 4 hours to 6 hours. A primer-surfacer composition provided by the present disclosure can have a pot life, for example, greater than 3 hours, greater than 4 hours, greater than 6 hours or greater than 8 hours. A primer-surfacer composition provided by the present disclosure can have a pot life, for example, less than 10 hours, less than 8 hours, or less than 6 hours. Pot life refers to the duration from when the primer-surfacer precursor composition and the crosslinker are combined until the time the primer-surfacer composition is no longer stirrable by hand.

A primer-surfacer composition provided by the present disclosure can have a dry-to-handle time, for example, of from about 30 minutes to 45 minutes at 25° C./40% RH for an initial wet-film thickness (WFT) of 20 mils (508 μm) or less. The dry-to-handle time can be longer for thicker wet films because of the time needed to evaporate the water. The air circulation in the spray booth and/or the use of air blower to dry the surface between coats can improve the dry-to-handle time. The dry-to-handle time refers to the duration from when the primer-surfacer composition is applied to a substrate to the time when a cotton ball does not adhere to the surface of the dried primer-surfacer coating.

A primer-surfacer composition provided by the present disclosure can be applied at a high film build such as, for example, up to 25 mils (635 μm), 30 mils (762 μm), 35 mils (889 μm), or 40 mils (1016 μm) dry film thickness (DFT) without any visible surface defects such as blisters and mud cracks, or sagging.

The time to apply a primer-surfacer composition, dry the applied primer-surfacer composition to provide the primer-surfacer coating, optionally abrading the coating, and applying a top coat can be, for example, from about 1 hour to 3 hours such as less than 3 hours, less than 2 hours, or less than 1 hour.

A two-part primer-surfacer coating system provided by the present disclosure can comprise a first part and a second part. The first part can comprise a primer-surfacer precursor composition provided by the present disclosure. A second part con comprise a crosslinker provided by the present disclosure.

A primer-surfacer coating provided by the present disclosure can comprise the same constitutes as in the primer-surfacer composition and in the same relative amounts, without the solvent and with the reactive components polymerized. A primer-surfacer coating refers to a cured primer-surfacer composition.

A primer-surfacer coating provided by the present disclosure can comprise a specific gravity, for example, from 0.6 to 1.1, from 0.6 to 1.0, from 0.6 to 0.9, or from 0.6 to 0.8. A primer-surfacer coating provided by the present disclosure can comprise a specific gravity, for example, greater than 0.6, greater than 0.7, greater than 0.8, greater than 0.9, greater than 1.0, or greater than 1.1. A primer-surfacer coating provided by the present disclosure can comprise a specific gravity, for example, less than 1.2, less than 1.0, less than 0.9, less than 0.8, less than 0.7, or less than 0.6.

A primer-surfacer coating provided by the present disclosure can exhibit adhesion to polar polymeric substrates of 4B or 5B determined according to ASTM D3359, Method B, following fluid immersion according to ASTM D1308 and humidity exposure according to ASTM D2247.

A primer-surfacer coating provided by the present disclosure can exhibit adhesion to water-based topcoats and to solvent-based topcoats of 4B or 5B determined according to ASTM D3359, Method B, following fluid immersion according to ASTM D1308 and humidity exposure according to ASTM D2247.

A primer-surfacer coating provided by the present disclosure can pass the 24-hour water immersion test according to ASTM D870.

A multilayer coating provided by the present disclosure can comprise a primer-surfacer coating provided by the present disclosure and an overlying coating.

The overlying coating can comprise a water-based coating or a solvent-based coating.

Examples of suitable water-based coatings include WPTA900001 and Selemix Aqua 8-110/9-125, available from PPG Industries, Inc.

Examples of suitable water-based refinish coatings include Envirobase® High Performance Waterborne Basecoat and Aquabase® Plus Waterborne Basecoat, available from PPG Industries, Inc.

Examples of suitable solvent-based coatings include Spectracron® SB systems available from PPG Industries, Inc.

Examples of suitable solvent-based refinish coatings include Deltron® 2000 Basecoat, Delfleet One™ available from PPG Industries, Inc.

A primer-surfacer composition can be applied to any suitable substrate to provide a primer-surfacer coating. A substrate can include any suitable substrate.

A suitable substrate can comprise a polymer substrate such as a thermoplastic polymer substrate or a thermoset polymer substrate.

A substrate can comprise any suitable polymeric substrate such as a substrate described herein.

A suitable substrate can include a polar polymeric substrate. A polar polymeric substrate can have a dielectric constant, for example, greater than 2.8, greater than 3.0, greater than 3.2, or greater than 3.4. The dielectric constant can be determined according over a frequency range from 10 Hz to 2 MHz according to ASTM D2520.

Examples of suitable polar polymeric substrates include acrylonitrile butadiene styrene/polycarbonate blend, acrylonitrile styrene acrylate, acrylonitrile/polycarbonate blend, cellulose acetate butyrate, cellulose acetate, cellulose propionate, chlorinated polyvinyl chloride, ethylene vinyl alcohol, polyacrylonitrile, polyamide, polyamide-imide, polyacrylate, polybutylene terephthalate, polycaprolactam, polycarbonate, polyetheretherketone, polyetherimide, polyethersulfone, polyethylene terephthalate, polyimide, polymethylmethacrylate, polyoxymethylene, polyphthalamide, polyphenylene sulfide, polyphenylene sulfone, polyvinyl acetate, polyvinyl chloride, polyvinylidene fluoride, poly(aminoalkyd), polyaniline, polyepoxy, polyester, polyacetal, polyacetol, polyacrylic ester, and polyether.

Non-polar polymeric substrates can also be used provided that the surface is pretreated to polarize the polymer surface. For example, suitable non-polar polymeric substrates having a dielectric constant less than 3.5 include polyacetal, poly(acrylonitrile), polycarbonate, polybutadiene, polybutene, polybutylmethacrylate, polycaprolactone, poly(2-chloro-p-xylene), poly(2-chlorostyrene), poly(4-chlorostyrene), poly(chlorotrifluoroethylene), poly(cyclohexyl methacrylate), poly(2,6-dimethyl-p-phenylene oxide), poly(2,6-diphenyl-p-phenylene oxide), poly(ethyl methacrylate), polyethylene terephthalate) m, polyethylene, poly(isobutene), poly(isobutyl methacrylate), poly(isobutylethylene), poly(methyl methacrylate), poly(2-methylstyrene), poly(4-methylstyrene), poly(1,4-phenyl ether), poly(propylene glycol), polypropylene, poly(p-xylene), poly(thio-1,4-phenylene), poly(alpha-methylstyrene), poly(tetramethylene terephthalate), polystyrene, polytetrafluoroethylene, polytetrahydrofuran, poly(vinyl acetate), polyvinyl chloride, polyvinylidene chloride, and polyvinylidene fluoride.

Examples of suitable polymeric substrates having a dielectric constant less than 3.5 include acrylonitrile butadiene styrene, ethylene tetrafluoroethylene, ethylene vinyl acetate, polyamide, polybutylene, polycarbonate, polyethylene, polymethyl pentene, polymethylmethacrylate, polyphenylene oxide, polypropylene, polyethylene, polyolefins, polystyrene, polytetrafluoroethylene, and styrene acrylonitrile.

Examples of suitable polymeric substrates include certain polyetherimides.

For example, a suitable polymeric substrate can comprise an elastomeric polymeric substrate. Examples of suitable elastomeric substrates include substrates made from polyethers, polybutadienes, fluoroelastomers, perfluoroelastomers, ethylene/acrylic copolymers, ethylene propylene diene terpolymers, nitriles, polythiolamines, polysiloxanes, chlorosulfonated polyethylene rubbers, isoprenes, neoprenes, polysulfides, polythioethers, silicones, styrene butadienes, and combinations of any of the foregoing.

A polymeric substrate can be made from a polymer that is chemically resistant. Examples of prepolymers having a chemically resistant include polytetrafluorethylene, polyvinylidene difluoride, polyethylenetetrafluoroethylene, fluorinated ethylene propylene, perfluoroalkoxy, ethylene chlorotrifluorethylene, polychlorotrifluoroethylene, fluorinated ethylene propylene polymers polyamide, polyethylene, polypropylene, ethylene-propylene, fluorinated ethylene-propylene, polysulfone, polyarylether sulfone, polyether sulfone, polyimide, polyethylene terephthalate, polyetherketone, polyetherether ketone, polyetherimide, polyphenylene sulfide, polyarylsulfone, polybenzimidazole, polyamideimide, liquid crystal polymers, and combinations of any of the foregoing.

The chemical resistance can be with respect to cleaning solvents, fuels, hydraulic fluids, lubricants, oils, and/or salt spray. Chemical resistance refers to the ability of a part to maintain acceptable physical and mechanical properties following exposure to atmospheric conditions such as moisture and temperature and following exposure to chemicals such as cleaning solvents, fuels, hydraulic fluid, lubricants, and/or oils. In general, a chemically resistant part has exhibits a percent (%) swell less than 25%, less than 20%, less than 15%, or less than 10%, following immersion in a chemical for 7 days at 70° C., where percent (%) swell is determined according to EN ISO 10563.

A primer surfacer composition provided by the present disclosure can be applied to a coating overlying a substrate. The coating can be, for example, a primer coating, and adhesion coating, or any other suitable coating. The coating can be polar and can have, for example, a dielectric constant greater than 2.8, greater than 3.0, greater than 3.2, or greater than 3.4 over a frequency range from 10 Hz to 2 MHz according to ASTM D2520.

A primer-surfacer composition provided by the present disclosure can be used to enhance adhesion between a substrate and an overlying coating and can be used to smooth substrate surfaces.

A primer-surfacer composition can be applied to rough surfaces as one or more layers to provide a smooth surface. One or more layers of a primer-surfacer composition can be applied to a surface and dried. A primer-surfacer coating can be abraded to further smooth the surface.

The rough topographical surface features can result from the manufacturing process and/or tooling used to fabricate the substrate. For example, the rough surface features can be print lines produced during additive manufacturing such as three-dimensional printing or selective laser sintering.

A primer-surfacer composition provided by the present disclosure can be used to level or smooth topographical features having a maximum height, for example, of less than 10 mils (254 μm), less than 20 mils (508 μm), less than 30 mils (762 μm), less than 40 mils (1016 μm), or less than 50 mils (1270 μm).

A primer surfacer composition provided by the present disclosure can be used to level or smooth topographical features having a maximum height, for example, from 1 mil (25 μm) to 50 mils (1270 μm), from 5 mils (127 μm) to 40 mils (1,016 μm) or from 10 mils (254 μm) to 20 mils (508 μm).

A primer-surfacer composition provided by the present disclosure can be used to level or smooth a surface having a surface profile, for example, from 10 mils (254 μm) to 25 mils (635 μm), such as from 15 mils (381 μm) to 20 mils (508 μm).

A primer-surfacer composition provided by the present disclosure can be used to level or smooth a substrate made using additive manufacturing.

Additive manufacturing broadly encompasses robotic and automated manufacturing methods adapted for coreactive compositions. Additive manufacturing includes, for example, three-dimensional printing, fused deposition modeling, extrusion, and coextrusion. Coreactive additive manufacturing includes methods of combining the coreactants, mixing the coreactants to form a coreactive composition, and extruding the coreactive composition through a nozzle onto a substrate and/or onto a previously deposited layer comprising the coreactive composition. Additive manufacturing can facilitate the use of fast cure chemistries, manufacturing flexibility, and customizability.

Using additive manufacturing methods, individual layers of a coreactive composition can be applied directly to a substrate and/or to a previously deposited layer and subsequently cured and/or allowed to cure.

Compositions provided by the present disclosure can be used to fabricate articles using additive manufacturing.

Additive manufacturing encompasses robotic and automated manufacturing methods including, for example, extrusion and three-dimensional printing. Three-dimensional printing encompasses processes used to fabricate three-dimensional articles in which successive layers of material are formed under computer control, for example, using a three-dimensional primer or computer numerical control (CNC) device having one or more extruders to create the article. Articles can be produced from digital model data. Three-dimensional printing includes methods that encompass depositing layers in three dimensions such as that curved shapes can be fabricated.

A method of coating a surface provided by the present disclosure can comprise applying a primer-surfacer composition provided by the present disclosure to a substrate and curing the applied composition to provide a cured coating.

The surface can be a surface of any suitable substrate.

Applying a coating composition provided by the present disclosure can comprise spraying, dipping, wiping, rolling, painting, squeezing, printing, additive manufacturing such as three-dimensional printing, extrusion, co-extrusion, using robotic methods, or a combination of any of the foregoing.

An applied primer-surfacer composition can have a thickness, for example, from 0.05 mils (1.27 μm) to 50 mils (1270 μm), from 10 mils (254 μm) to 40 mils (1016 μm), or from 20 mils (508 μm) to 30 mils (762 μm).

Curing an applied primer-surfacer composition can comprise drying the applied primer-surfacer composition. During drying the neutralizing agents such as water and organic solvent evaporate from the applied coating composition causing the crosslinking agent and the carboxyl groups of the prepolymers to react. The applied primer-surfacer composition can partially cure during and/or after drying.

An applied primer-surfacer composition can be dried/cured, for example, at a temperature from 20 C to 50 C, from 200° C. to 40° C., from 20° C. to 30° C., or from 20° C. to 25° C. An applied primer-surfacer composition can be dried/cured, for example, at a temperature greater than 10° C., greater than 25° C., greater than 30° C., or greater than 40° C. An applied primer-surfacer composition can be dried/cured, for example, at a temperature less than 40° C., less than 30° C., or less than 25° C.

Depending on the temperature an applied primer-surfacer composition can be dried/cured, for example, for a duration less than 3 hours, less than 2 hours, less than 1 hours, less than 30 minutes or for less than 15 minutes. For example, at a temperature from 20° C. to 25° C., an applied primer-surfacer composition can be dried/cured for from 15 minutes to 60 minutes.

A primer-surfacer coating can have an average thickness, for example, from 1 mil to 50 mils (25.4 μm to 1270 μm), from 1 mil to 20 mils (25.4 μm to 508 μm), from 1 mil to 10 mils (25.4 μm to 254 μm), from 15 mils to 45 mils (381 μm to 1143 μm), from 20 mils to 40 mils (508 μm to 1016 μm), or from 25 mils to 35 mils (635 μm to 889 μm). A primer-surfacer coating can have an average thickness, for example, greater than 10 mils (254 μm), greater than 20 mils (508 μm), greater than 30 mils (762 μm), or greater than 40 mils (1016 μm). A primer-surfacer coating can have an average thickness, for example, less than 50 mils (1270 μm), less than 40 mils (1016 μm), less than 30 mils (762 μm), or less than 20 mils (508 μm).

For adhesive applications the average thickness can be, for example, from 10 mils to 150 mils (0.25 mm to 3.8 mm), from 10 mils to 125 mils (0.25 mm to 3.17 mm), or from 10 mils to 100 mils 0.25 mm to 2.5 mm).

A primer-surfacer coating can be considered fully cure when the hardness of the primer-surfacer coating, such as the pendulum hardness reaching a plateau as determined according to ASTM D4366-16 or ISO 1522.

A primer-surfacer composition provided by the present disclosure can be applied as a single layer or as multiple layers to provide a primer-surface coating.

A primer-surfacer coating provided to the present disclosure can exhibit adhesion to high surface energy surfaces such as polymeric surfaces including certain thermoplastic surfaces and thermoset surfaces. A primer-surfacer coating can exhibit adhesion to a high energy surface such as a polymeric substrate that has been prepared by wiping the surface with an alcoholic solvent such as isopropanol. High-energy substrates include polar substrates having a dielectric constant greater than about 2.8 or greater than about 3.0.

Examples of suitable high-energy substrates include acrylonitrile butadiene styrene/polycarbonate blend, acrylonitrile styrene acrylate, acrylonitrile/polycarbonate blend, cellulose acetate butyrate, cellulose acetate, cellulose propionate, chlorinated polyvinyl chloride, ethylene vinyl alcohol, polyacrylonitrile, polyamide, polyamide-imide, polyacrylate, polybutylene terephthalate, polycaprolactam, polycarbonate, polyetheretherketone, polyetherimide, polyethersulfone, polyethylene terephthalate, polyimide, polymethylmethacrylate, polyoxymethylene, polyphthalamide, polyphenylene sulfide, polyphenylene sulfone, polyvinyl acetate, polyvinyl chloride, and polyvinylidene fluoride

A substrate such as a polymer substrate can be fabricated using any suitable methods such as extrusion, compression molding, transfer molding, thermoforming, laminating, additive manufacturing including three-dimensional printing, and machining.

A top coat can be applied to a cured primer surfacer coating.

A top coat can be applied to the primer-surfacer coating after the primer-surfacer has been abraded and cleaned using a solvent such as isopropanol. For some application it is not necessary to abrade the primer-surfacer coating before applying one or more top coats, in which case the primer-surfacer coating can be solvent wiped using a solvent such as isopropanol.

A primer-surfacer composition provided by the present disclosure can be used to level surfaces and/or to enhance adhesion between a substrate such as a polymer substrate and an overlying coating.

A suitable polymer substrate such as a thermoplastic or thermoset substrate can be made using any suitable molding technology including, for example, extrusion, coextrusion, thermoforming, compression molding, injection molding, blow molding, rotational molding, casting, laminating, additive manufacturing including three-dimensional printing, fused deposition modeling, VAT polymerization, powder bed fusion, material jetting, binder jetting, sheet lamination, or directed energy deposition.

A substrate can include a metal substrate. A substrate can include a combination of materials such as a polymeric substrate and a metal substrate. A substrate can comprise a thermoplastic and a thermoset.

A primer-surfacer composition provided by the present disclosure can be used on a surface of any suitable part. Examples of suitable parts include vehicle parts, architectural parts, construction parts, electronic parts, furniture, medical devices, portable devices, telecommunications devices, athletic equipment, apparel, and toys.

Parts such as vehicle parts including construction equipment parts, heavy machinery parts, construction equipment parts, automotive vehicle parts and aerospace vehicle parts made using additive manufacturing such as three-dimensional printing.

A primer-surfacer composition provided by the present disclosure can be used to coat internal and external vehicle parts such as motor vehicle parts, railed vehicle parts, aerospace vehicle parts, military vehicle parts, and watercraft parts.

Any suitable vehicle part can be coated using a primer-surfacer composition provided by the present disclosure.

A vehicle part can be a new part or a replacement part.

The term “vehicle” is used in its broadest sense and includes all types of aircraft, spacecraft, watercraft, and ground vehicles. For example, a vehicle can include, aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, scooters, trains, and railroad cars. A vehicle can also include watercraft such as, for example, ships, boats, and hovercraft. A vehicle can be, for example, a motor vehicle, including automobile, truck, bus, van, motorcycles, scooters, and recreational motor vehicles; railed vehicles including trains and trams; bicycles; aerospace vehicles including airplanes, rockets, spacecraft, jets, and helicopters; military vehicles including jeeps, transports, combat support vehicles, personnel carriers, infantry fighting vehicles, mine-protected vehicles, light armored vehicles, light utility vehicles, and military trucks; and watercraft including ships, boats, and recreational watercraft.

A vehicle part can be a part of any type of aircraft, spacecraft, watercraft, and ground vehicles. For example, a vehicle part can include a part of an aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, scooters, trains, and railroad cars. A vehicle can also include watercraft such as, for example, ships, boats, and hovercraft. A vehicle part can be, for example, part for a motor vehicle, including automobile, truck, bus, van, motorcycles, scooters, and recreational motor vehicles; railed vehicles including trains and trams; bicycles; aerospace vehicles including airplanes, rockets, spacecraft, jets, and helicopters; military vehicles including jeeps, transports, combat support vehicles, personnel carriers, infantry fighting vehicles, mine-protected vehicles, light armored vehicles, light utility vehicles, and military trucks; and watercraft including ships, boats, and recreational watercraft.

Examples of aviation vehicles include F/A-18 jet or related aircraft such as the F/A-18E Super Hornet and F/A-18F; in the Boeing 787 Dreamliner, 737, 747, 717 passenger jet aircraft, a related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Methods provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd; produced by Eclipse Aviation Corporation; or produced by Eclipse Aerospace (Kestrel Aircraft).

A vehicle part can be an interior vehicle part or an exterior vehicle part.

A vehicle can comprise a motor vehicle and the motor vehicle part can comprise a hood, door, side panel, bumper, roof, wheel well, dashboard, seat, trunk, handle, floor, chassis, cabin, cargo bed, steering wheel, fuel tank, engine block, trim, bumper, console, instrument panel, armrest, headliner, airbag cover, mirror housing, grille, cladding, and/or a battery casing.

A vehicle can comprise a railed vehicle and the railed vehicle part can comprise an engine and/or a rail car.

A vehicle can comprise an aerospace vehicle and the aerospace part can comprise a cockpit, fuselage, wing, aileron, tail, door, seat, interior panel, fuel tank, interior panel, flooring, and/or frame.

A vehicle can comprise a military vehicle and the military vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, a mount, a turret, an undercarriage, and/or a battery casing.

A vehicle can comprise a watercraft and the watercraft part can comprise a hull, an engine mount, a seat, a handle, a chassis, a battery, a battery mount, a fuel tank, an interior accessory, flooring, and/or paneling.

A vehicle part coated using a primer-surfacer composition provided by the present disclosure can have properties for the intended purpose. For example, an automotive part can be designed have a light weight. An external part for military vehicle can be designed to have a high impact strength.

A part for a commercial aerospace vehicle can be designed to have a light weight and/or to be static dissipative. An external part for a military aircraft can be designed to exhibit RFI/EMI shielding properties.

A primer-surfacer composition provided by the present disclosure can be adapted to coat custom designed vehicle parts, replacement parts, upgraded parts, specialty parts, and/or high-performance parts rapidly and cost-effectively in low volume production.

Examples of architectural and construction parts include pipes, such as plumbing pipes, potable water pipes, and drain pipes; conduit, such as electrical conduit; electrical wiring; lumber and composites, such as composite decking, wood decking, plastic decking, fencing, wall paneling, plastic sheeting, rubber sheeting, and pressure treated wood; roofing materials, such as metal roofing, asphalt shingles, roof flashing, gutters, and vents; cabinetry; flooring, such as composite flooring, laminate flooring, vinyl flooring, nylon flooring, carpet, gym flooring, garage flooring, and sealed stone or ceramic flooring; siding, such as vinyl siding, aluminum siding, composite siding, veneer siding, and cementitious siding; insulation, such as fiberglass insulation and foam insulation; ceiling tiles; trim, such as window trim, door trim, molding; fixtures, such as lighting fixtures, tubs, sinks, and showers; underlayments; leak barriers; and waterproofing membranes.

A part can comprise an elastomeric article such as, for example, seals, sealants, grommets, gaskets, washers, bushings, flanges, insulation, apparel, shoe soles, boots, footwear, handles, bumpers, shock absorbers, matting, tires, supports, automotive parts, vehicle parts, aerospace parts, marine parts, athletic equipment, toys, novelty items, and casings.

An aspect of the invention includes parts comprising a primer-surfacer coating provided by the present disclosure.

### EXAMPLES

Embodiments provided by the present disclosure are further illustrated by reference to the following examples, which describe primer-surfacer precursor compositions, primer surfacer compositions and primer-surfacer coatings provided by the present disclosure, uses of the primer surfacer compositions to prepare primer-surfacer coatings. It will be apparent to those skilled in the art that many modifications, both to materials, and methods, may be practiced without departing from the scope of the disclosure.

### Example 1

### Primer-Surfacer Composition (1)

The constituents of a primer-surfacer composition are shown in Table 1.

The Part A constituents were combined and mixed using a mill. Organic solvent was added as a washout, and the other constituents were added as a letdown to prepare the primer-surfacer precursor composition.

TABLE 1
Primer-surfacer composition (1).

| | Wt % | Vol % |
|---|---|---|
| Part A | | |
| Carboxyl-functional | 29.3 | 26.7 |
| polyurethane prepolymer | | |
| dispersion | | |
| Distilled water | 1.2 | 1.1 |
| Silicone defoamer | 0.6 | 0.6 |
| Microfibrillated cellulose | 3.7 | 3.3 |
| Organic solvent (1) | 1.2 | 1.2 |
| Organic solvent (2) | 1.2 | 1.2 |
| Dispersant | 1.5 | 1.3 |
| Talc | 2.9 | 1.0 |
| Mica | 2.3 | 0.8 |
| Aluminum hydroxide | 7.0 | 2.8 |
| Titanium dioxide | 5.3 | 1.2 |
| Organic solvent (3) | 2.3 | 2.3 |
| Organic solvent (4) | 1.8 | 1.8 |
| Carboxyl-functional acrylic | 14.7 | 13.2 |
| copolymer dispersion | | |
| Acrylic dispersion | 14.7 | 13.5 |
| Dispersant | 1.2 | 1.0 |
| Low-density microspheres (1) | 7.6 | 21.2 |
| Low-density microspheres (2) | 1.2 | 5.3 |
| Fluorocarbon modified | 0.5 | 0.42 |
| polyacrylate leveler | | |
| Thickener | 0.06 | 0.05 |
| Colorant | 0.02 | 0.007 |
| Part B | | |
| Crosslinker | 2.0 | — |

The properties of the Part A and Part B components are shown in Table 2 and the properties of the combined Part A and Part B components are shown in Table 3.

TABLE 2
Properties of Part A and Part B
primer-surfacer components.

| Property | Part A | Part B |
|---|---|---|
| Density (g/cm³) | 0.95 | 1.10 |
| PVC (%) | 60.3 | 0.0 |
| Weight Solid (%) | 51.4 | 100.0 |
| Volume Solids (%) | 53.5 | 100.0 |
| Total VOC (g/L) | 102 | 0.0 |
| Actual VOC less exempt | 61.6 | 0.0 |
| less water (g/L | | |
| Calculated VOC less | 102 | 0.0 |
| exempt less water (g/L) | | |
| P/B ratio | 1.05 | 0.00 |

TABLE 3
Properties of the primer-surfacer
(combined Part A and Part B).

| | Combined |
|---|---|
| Property | Part A + Part B |
| Mix Ratio (Weight) | 100/2 |
| Mix Ratio (Volume) | 60/1 |
| Mixed Density (g/cm³) | 0.95 |
| Total PVC | 58.5 |
| % Volume Solids (mixed) | 54.3 |
| Total Mixed VOC (g/L) | 99.6 |
| Actual Mixed VOC | 60.5 |
| less exempt less water (g/L) | |
| Calculated Mixed VOC less | 99.6 |
| exempt less water (g/L) | |
| P/B ratio | 0.98 |

Substrates were fabricated using three-dimensional printing. Ultem® 9085 (polyetherimide) substrates were fabricated by fused filament fabrication and nylon (polyamide) substrates were fabricated using selective laser sintering (SLS). The substrate surfaces had visible print lines separated by about 5 mm to 6 mm, and at an angle of about 2.5 degrees.

The substrates were cleaned by wiping the surfaces with isopropanol before applying the coating.

The Part A and Part B components were combined in a spray cup, and the primer-surfacer composition was sprayed onto the surface of the panels. Panels were spray coated at 25° C./40% RH.

The application parameters for the spray methods used to apply the primer-surfacer provided in Table 4.

TABLE 4
Spray application parameters.

| | | Wet film | |
|---|---|---|---|
| | | thickness | |
| | | per pass | Spray- |
| Application Method | Parameters | (mil/μm) | ability |
| Airless | 39:1 pump, 1500 psi, | 9/229 | Good |
| | 1.3 mm tip | | |
| Air-assisted airless | 39:1 pump, 1535 psi, | 14/356 | Excellent |
| | 1.3 mm tip | | |
| HVLP (gravity feed) | 40 psi inlet, 1.8 mm tip | 6/152 | Good |
| HVLP (pressure-pot) | 40 psi inlet, 1.8 mm tip | 9/229 | Excellent |

The viscosity of the primer-surfacer composition was adjusted with distilled water up to 10% by weight, depending on the application methods and the desired film build.

Three passes were sprayed for each application method.

The coated panels were flashed a 25° C./40% RH for from 30 min to 45 min, followed by heating at 40° C. to 50° C. for from 45 min to 60 min to dry the applied primer-surfacer composition. The flash time and heating time were varied depending on the film thickness.

The panels were cooled to 25° C. and the surfaces sanded with 240 grit to 320 grit sand paper. The sanded panels were wiped clean with isopropanol before applying a top coat.

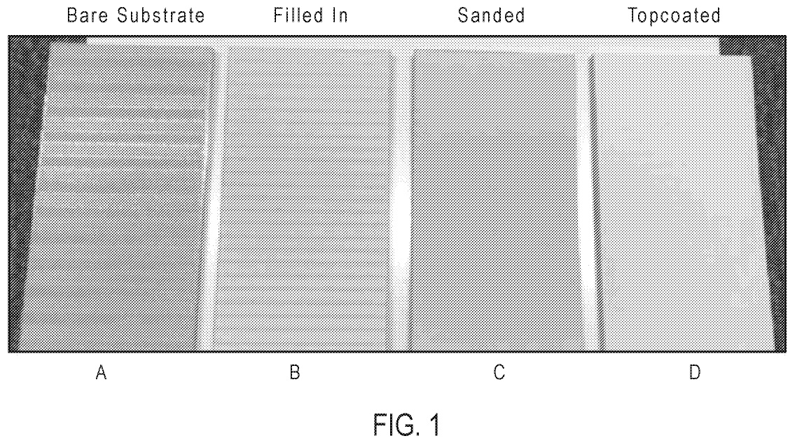

FIGS. 1A-1D show surfaces at various stages in the coating process.

A printed substrate showing 15 mil to 20 mil (381 μm to 508 μm) deep parallel print lines is shown in FIG. 1A. The primer-surfacer composition was sprayed onto the substrate at 20° C./40% RH using an HVLP spray gun with a 1.8 mm tip. The applied primer-surfacer composition was cured at 60° C. for 45 minutes. The surface of the panel with the print lines filled with the primer-surfacer composition is shown in FIG. 1B. The filled surface was then leveled by abrading with a 320 grit to 400 grit sand paper. The abraded surface is shown in FIG. 1C. A solvent-borne topcoat or water-borne topcoat was then sprayed over the leveled surface containing the primer-surfacer coating. The coated panel was then cured at 25° C./40% RH for 7 days. A photograph of the coated surface is show in FIG. 1D.

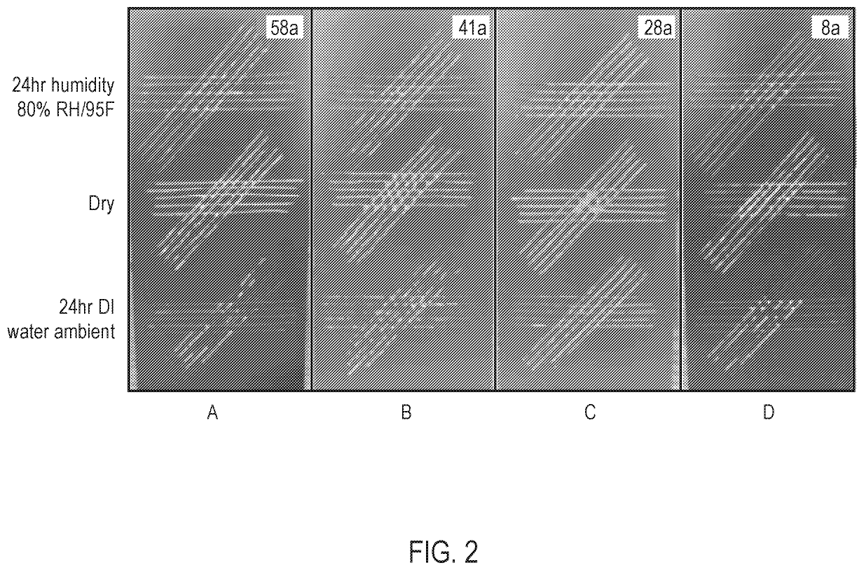

The results of an adhesion test of the test panels is shown in FIGS. 2A-2D. Adhesion was determined using the X-cut adhesion test as according to ASTM D3359 (Test Method A).

The materials used in the test panels shown in FIGS. 2A-2D are summarized in Table 5.

TABLE 5
Materials used to prepare the X-cut adhesion
panels shown in FIGS. 2A-2D.

| Material | | | | |
|---|---|---|---|---|
| Layer | FIG. 2A | FIG. 2B | FIG. 2C | FIG. 2D |
| Substrate | ¹ FFF Ultem ™ | FFF Ultem ™ | FFF Ultem ™ | SLS Nylon |
| | 2.5 degrees | 2.5 degrees | 0 degrees | |
| Layer 1 | ² Primer- | ² Primer- | ² Primer- | ² Primer- |
| | Surfacer | Surfacer | Surfacer | Surfacer |
| Layer 2 | Primer | Primer | Primer | Primer |
| Topcoat | Water-borne | Solvent-borne | Solvent-borne | Water- |
| | | | | borne |

¹ FFF Ultem ™ 2.5 degree represents a worst-case surface profile, and FFF Ultem ™ 0 degree represents a smooth surface.
² Primer-surfacer provided by the present disclosure.

Each test panel had three sections, from the top to bottom in FIGS. 2A-2D. The (a) top sections were exposed to high humidity at 35° C./80% RH for 24 hours; (b) the middle sections to dry conditions at 25° C./40% RH for 24 hours; and (c) the bottom sections were immersed in distilled water for 24 hours at 25° C.

The test panels (2A-2C) were fabricated using fused filament fabrication (FFF) three-dimensional printing technology with an polyetherimide resin (Ultem™ 9085 at a nozzle angle of 2.5 degrees with respect to the surface. A polyamide test panel was fabricated using selective laser sintering additive manufacturing technology.

The test panels were abraded using dual action pneumatic sander with 220 grit or 320 grit sanding paper.

Panels with a primer-surfacer coating provided by the present invention and an overlying topcoat were post-cured at 25° C./40% RH, and the properties were tested after both overnight post cure and 7-day post cure.

The water soak crosshatch dry and wet adhesion were tested before and after water immersion for 24 hours at 25° C. according to ASTM D870.

Humidity crosshatch dry and wet adhesion were tested before and after humidity chamber (100% humidity, 40° C.) for 24 hours ASTM D2247.

For the peel tests 3M Scotch™ 250 tape was used.

Dry and wet adhesion to FFF Ultem™ 9085 (PEI) and SLS Nylon substrates and intercoat adhesion to water-based topcoats were acceptable for the test panels having either the primer-surfacer coating provided by the present disclosure alone, or both the primer-surfacer coating provided by the present disclosure with an overlying coating when cured at 50° C. to 60° C. elevated temperature condition for from 30 minutes to 45 minutes.

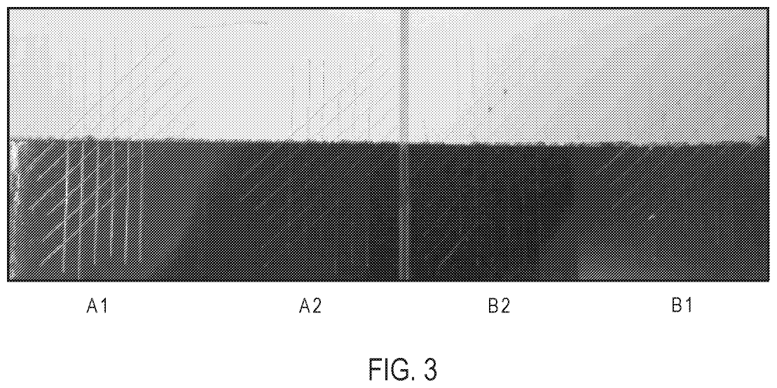

FIGS. 3A1-3B2 show dry and wet water soak adhesion as determined using the cross-hatch test to a FFF Ultem™ 9085 substrates with a primer-surfacer coating provided by the present disclosure alone (top half) and or with a primer-surfacer coating provided by the present disclosure/water-based topcoat PPG WPTA900001 (2K polyurethane high gloss black topcoat) (bottom half).

For FIG. 3A the test panel was cured at 60° C. for 45 min and then post-cured for 7 days at 25° C./40% RH. The left side of the panel was then immersed in water for 24 hours at 25° C.

For FIG. 3B the test panel was cured at 60° C. for 45 min and then post-cured for 24 hours at 25° C./40% RH. The right side of the test panel was then immersed in water for 24 hours at 25° C.

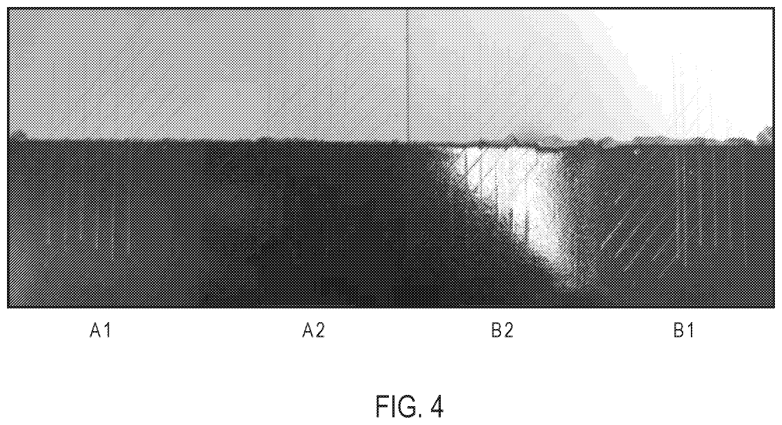

FIGS. 4A1-4B2 show dry and wet water soak adhesion to a SLS Nylon substrate with a primer-surfacer coating provided by the present disclosure alone (top half) or with a primer-surfacer coating provided by the present disclosure and an overlying water-based topcoat PPG WPTA900001 (2K polyurethane high gloss black topcoat) (bottom half).

For FIG. 4A the panel was cured at 60° C. for 45 min and then post-cured for 24 hours at 25° C./40% RH. The left side of the test panel was then immersed in water for 24 hours at 25° C.

For FIG. 4B the panel was cured at 60° C. for 45 min and then post-cured for 7 days at 25° C./40% RH. The right side of the panel was then immersed in water for 24 hours at 25° C.

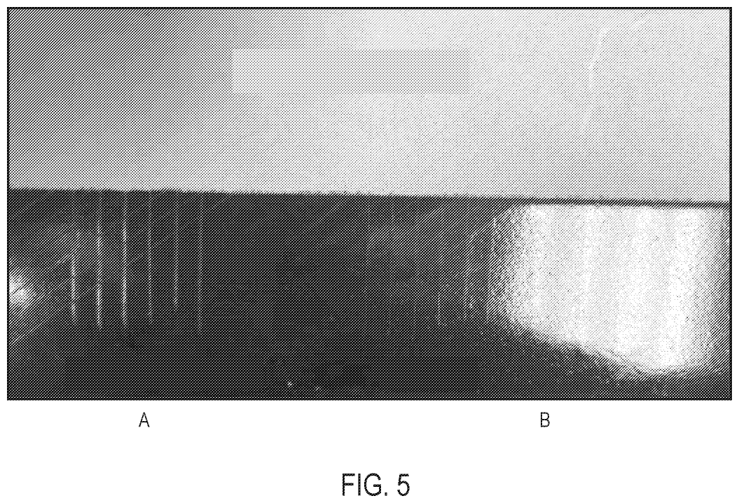

FIGS. 5A-5B show dry and wet humidity adhesion to a FFF Ultem™ 9085 substrate with a primer-surfacer coating provided by the present disclosure alone (top half) or with a primer-surfacer coating provided by the present disclosure and an overlying water-based topcoat PPG WPTA900001 (2K polyurethane high gloss black topcoat) (bottom half). The test panel was cured at 60° C. elevated temperature for 45 min and then post-cured for 7 days at 25° C./40% RH. The left side of the test panel was then immersed in water for 24 hours at 25° C.

Two-part (2K) water-based primer-surfacer prototype provides good dry and wet adhesion over 3D printed FFF Ultem™ 9085 and SLS Nylon substrates, as well as good intercoat adhesion with water-based topcoat.

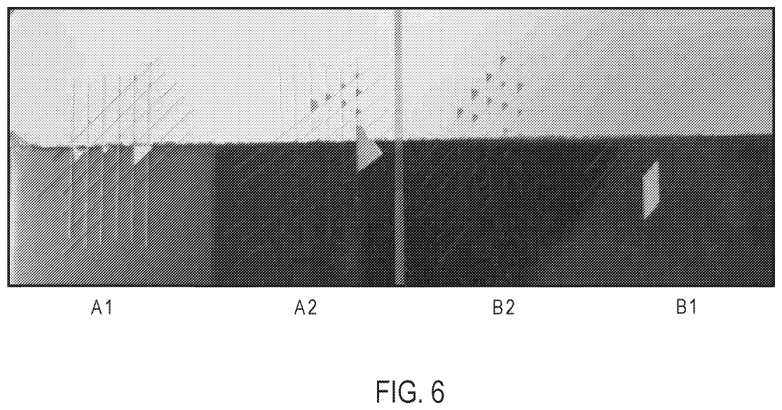

FIGS. 6A1-62 show dry and wet water soak adhesion to a FFF Ultem™ 9085 substrate with a primer-surfacer coating provided by the present disclosure alone (top half) or with a primer-surfacer coating provided by the present disclosure and an overlying water-based topcoat PPG WPTA900001 (2K polyurethane high gloss black topcoat) (bottom half).

For FIG. 6A the test panel was cured for 24 hours at 25° C./40% RH followed by a post-cure for 24 hours at 25° C./40% RH. The left side of the panel was then immersed in water for 24 hours at 25° C.

For FIG. 6B the panel was cured for 24 hours at 25° C./40% RH followed by a post-cure for 7 days at 25° C./40% RH. The right side of the test panel was then immersed in water for 24 hours at 25° C.

There was some adhesion loss for the coatings when cured at ambient condition as shown in FIG. 6A This could be due to softening of the thermoplastic substrate when heated which could improve the bonding between the resins and substrates; or because water remains in the surfacer coating long enough to interfere with the adhesion to the substrate and intercoat adhesion to topcoat.

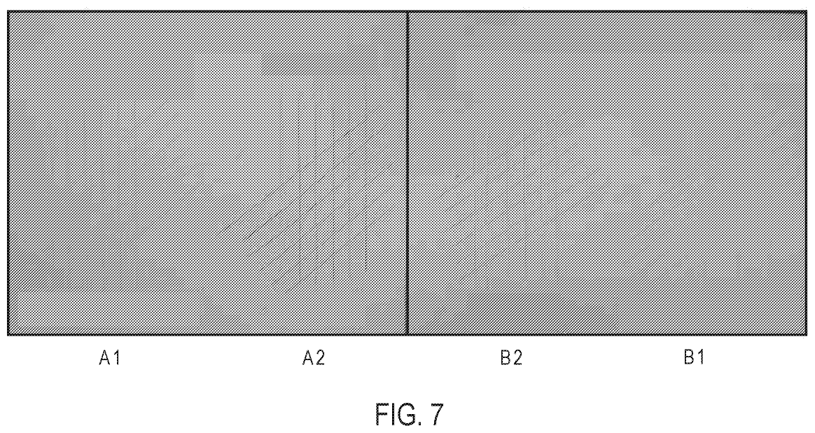

FIGS. 7A1-7B2 show dry and wet water soak adhesion of a primer-surfacer and a water-based topcoat (Mankiewicz ALEXIT FST-Topcoat 346-57) over a PC/ABS (Cycoloy™ Resin MC8002) substrate.

For FIG. 7A the test panel was cured for 24 hours at 25° C./40% RH. The left side of the panel was then immersed in water for 24 hours at 25° C.

For FIG. 7B the panel was cured for 24 hours at 25° C./40% RH followed by a post-cure for 7 days at 25° C./40% RH. The right side of the panel was then immersed in water for 24 hours at 25° C.

As shown in FIGS. 7A1-7B2, the inventive primer-surfacer provided good dry and wet adhesion to a Cycoloy™ Resin MC8002 substrate (extruded polycarbonate/acrylonitrile butadiene styrene (PC/ABS); Sabic North America).

### Example 2

### Primer-Surfacer Composition (2)

The constituents of a 2K (two-part) primer-surfacer composition including an aliphatic polyester polyol are shown in Table 6.

TABLE 6
Constituents of Part A and Part B primer-surfacer.

| | Amount (wt %) |
|---|---|
| Part A | |
| Carboxyl-functional | 28.1 |
| aliphatic polyurethane | |
| prepolymer dispersion | |
| Water | 1.1 |
| Silicone defoamer | 0.6 |
| Microfibrillated cellulose | 3.7 |
| Organic solvent (1) | 1.1 |
| Organic solvent (2) | 1.1 |
| Dispersant | 1.4 |
| Talc | 2.8 |
| Mica | 2.2 |
| Aluminum hydroxide | 6.7 |
| Titanium dioxide | 5.1 |
| Organic solvent (3) | 2.2 |
| Organic solvent (4) | 1.7 |
| Carboxyl-functional | 28.1 |
| acrylic copolymer | |
| dispersion | |
| Polyester polyol | 2.0 |
| Dispersant | 1.1 |
| Low-density filler | 8.6 |
| Fluorocarbon modified | 0.5 |
| polyacrylate leveler | |
| Thickener | 0.05 |
| Colorant | 0.02 |
| Part B | |
| Crosslinker | 2.0 |

Glass bubble K37 from 3M™ (0.37 g/cc, 45 μm diameter) and Spherical 34P30 from Potters Industries (34 g/cc, 10 μm to 70 μm diameter) were used as low-density filler to reduce the specific gravity of the primer-surfacer.

The properties of the Part A and Part B components are shown in Table 7 and the properties of the combined Part A and Part B components are shown in Table 8.

TABLE 7
Properties for Part A and Part B components.

| Property | Part A | Part B |
|---|---|---|
| Density (g/cm³) | 0.99 | 1.1 |
| PVC (%) | 56.2 | 0.0 |
| Weight Solid (%) | 51.1 | 100 |
| Volume Solids (%) | 51.6 | 100 |
| Total VOC (g/L) | 108 | 0.0 |
| Actual VOC Less Exempt | 63 | 0.0 |
| less water (g/L) | | |
| Calculated VOC Less | 108 | 0.0 |
| Exempts less water (g/L) | | |
| P/B ratio | 1.0 | 0.0 |

TABLE 8
Properties of the primer-surfacer
(combined Part A and Part B).

| | Combined |
|---|---|
| Property | Part A + Part B |
| Mix Ratio (by weight) | 100/2 |
| Mix Ratio (by volume) | 60/1 |
| Mixed Density (g/cm³) | 0.99 |
| Total PVC | 54.5 |
| % Volume Solids (mixed) | 52.4 |
| Total Mixed VOC (g/L) | 105 |
| Actual Mixed VOC less | 62.0 |
| exempt less water (g/L) | |
| Calculated Mixed VOC less | 105 |
| exempt less water (g/L) | |
| P/B ratio | 0.93 |

### Example 3

### Comparative Formulations

The prepolymer constituents for various primer-surfacer composition are shown in Table 9.

Coatings prepared using the inventive primer-surfacer compositions exhibited good adhesion to polymer substrates and to overlying coatings and exhibited good leveling ability.

Coatings prepared using the comparative primer-surfacer compositions exhibited poor adhesion to polymer substrates and poor leveling ability.

TABLE 9
Prepolymer constituents for various primer-surfacer compositions.

| Primer-surfacer | | |
|---|---|---|
| Compositions | Part A | Part B |
| Inventive | ¹ Polyurethane dispersion | ¹² PZ-28 or ¹³ PAX-523 |
| Compositions | ² Acrylic copolymer dispersion | |
| | ³ Acrylic dispersion | |
| | Mix Ratio 2/1/1 by wt % | |
| | ¹ Polyurethane dispersion | PZ-28 or PAX-523 |
| | ² Acrylic copolymer dispersion | |
| | ⁴ Polyester polyol | |
| Comparative | ¹ Polyurethane dispersion | PZ-28 or ¹⁴CX-100 |
| Compositions | ² Acrylic copolymer dispersion | |
| | ⁵ Polyurethane dispersion | PZ-33 or CX-100 |
| | ² Acrylic copolymer dispersion | |
| | ⁵ Polyurethane dispersion | PZ-28 |
| | ⁶ Urethane/acrylic dispersion | |
| | ⁵ Polyurethane dispersion | PZ-28 |
| | ⁷ Resin LC-55-1321 | |
| | ¹ Polyurethane dispersion | PZ-28, PZ-33, or CX-100 |
| | ⁸ Acrylic copolymer emulsion | |
| | ¹ Polyurethane dispersion | PZ-28 |
| | ⁹ Acrylic dispersion | |
| | ¹ Polyurethane dispersion | |
| | ² Acrylic copolymer dispersion | |
| | ¹ Polyurethane dispersion | PZ-28 |
| | ¹⁰ Anionic binder | |
| | ¹ Polyurethane dispersion | PZ-28 |
| | ¹¹ Polyester/urethane dispersion | |

¹ Daotan ® TW 6490/35WA, waterborne aliphatic polyurethane dispersion, available from Allnex GmbH.
² Setaqua ® 6754/37WA, acrylic copolymer dispersion, available from Allnex GmbH.
³ Joncryl ® 2981, self-crosslinking acrylic dispersion, available from BASF.
⁴ K-Flex ® 188, aliphatic polyester polyol, available from King Industrials.
⁵ Daotan ® TW 6450/30WA, polycarbonate based aqueous aliphatic polyurethane dispersion, available from Allnex GmbH.
⁶ Daotan ® VTW 6462/36WA, aqueous dispersion of an aliphatic urethane-acrylic hybrid self-cross-linking dispersion, available from Allnex GmbH.
⁷ Resin LC-55-1321, available from PPG Industries, Inc.
⁸ NeoCry ®1 A-6075, aqueous acrylic copolymer emulsion, available from DSM Coating Resins.
⁹ Setaqua ™ 6766, acrylics, available from Allnex GmbH.
¹⁰ Acronal ® LR 9014, fine particle anionic binder, available from BASF.
¹¹ Sancure ® 20025F, soft elastic aliphatic polyester urethane polymer dispersion, available from Lubrizol Performance Coatings.
¹² PZ-28, propylene imine tri-functional polyaziridine, available from PolyAziridine, LLC.
¹³ PAX-523, multifunctional polymeric aziridine, available from DSM Coating Resins, LLC.
¹⁴CX-100, polyaziridine crosslinker, available from DSM Coating Resins.

### Example 4

### Solvent Adhesion Testing

Test panels were prepared using selective laser sintering (SLS) of nylon and the coating of Example 1 was applied to a thickness of from about 5 μm to 10 μm. The applied coating was cured under ambient conditions or baked at 65° C. for from 30 to 45 minutes. The cured SLS nylon test panels were immersed in various solvents for 240 hours at 25° C. or exposure to 100% RH for 240 hours. Fluid immersion resistance was determined according to ASTM D1308 and humidity exposure according to ASTM D2247. The adhesion was determined according to ASTM D3359, Method B. The results are provided in Table 10.

TABLE 10
Adhesion results after 240 hours solvent exposure.

| | Ambient Cure | Bake |
|---|---|---|
| | (73° F./23° C.), | (150° F./65° C.; |
| Test | <25% RH) | 30-45 min) |
| Initial adhesion (7-day post cure) | 5B | 5B |
| Humidity (wet adhesion) | 5B (no blister) | 5B (no blister) |
| Water immersion (wet adhesion) | 4B (no blister) | 5B (no blister) |
| Diesel fuel (ASTM D975) | 4B (no blister) | 4B (no blister) |
| (wet adhesion) | | |
| Oil 10W30 (wet adhesion) | 4B (no blister) | 4B (no blister) |
| Pencil Hardness (ASTM D3363) | HB-F | F-H |
| Chip resistance (ASTM D3170) | 5B | 5B |

A similar test was performed in which the exposure time was extended to 500 hours at 25° C. The results are presented in Table 11.

TABLE 11
Adhesion results after 500 hours solvent exposure.

| | Ambient Cure | Bake |
|---|---|---|
| | (73° F./23° C.), | (150° F./65° C.; |
| Test | <25% RH) | 30-45 min) |
| Initial adhesion (7-day post cure) | 5B | 5B |
| Humidity (wet adhesion) | 5B (no blister) | 5B (no blister) |
| Water immersion(wet adhesion) | 4B (no blister) | 5B (no blister) |
| Diesel fuel (ASTM D975) | 4B (no blister) | 4B (no blister) |
| (wet adhesion) | | |
| Oil 10W30 (wet adhesion) | 4B (no blister) | 4B (no blister) |

The primer surfacer coating of Example 1 was applied to several different plastic substrates and cured either at 25° C., 50% RH for 7 days or at 50° C. for 30 min to 60 min. The cured test panels were immersed and water for three (3) weeks at 25° C. and adhesion evaluated according to ASTM D3359, Method B The results are presented in Table 12.

TABLE 12
Three-week water immersion and humidity
adhesion test results over different plastic substrates.

| Result | Substrate Material |
|---|---|
| Pass (5B) | Noryl ® GTX902 |
| | (PA/PC/PPE polyphenylene ether) |
| | Cycoloy ® MC8002 (PC/ABS), |
| | SMC (sheet mold compound, |
| | glass fiber embedded) |
| | Xenoy ® (PC/PBT or PET/PE), |
| | SLS nylon |
| Fail (0B) | Ultramid ® (40% glass fiber nylon) |

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof

### Example 5

### Primer-Surfacer Composition (3)

The constituents of a 2K (two-part) primer-surfacer composition including an aliphatic polyester polyol are shown in Table 7. In this case, the primer surfacer composition was substantially similar to primer-surfacer composition (1), without the inclusion of the low-density filler particles. Table 7. Primer-surfacer composition (3).

| | Wt % |
|---|---|
| Part A | |
| Carboxyl-functional | 32.1 |
| polyurethane prepolymer | |
| dispersion | |
| Distilled water | 1.3 |
| Silicone defoamer | 0.7 |
| Microfibrillated cellulose | 4.1 |
| Organic solvent (1) | 1.3 |
| Organic solvent (2) | 1.3 |
| Dispersant | 1.6 |
| Talc | 3.2 |
| Mica | 2.5 |
| Aluminum hydroxide | 7.7 |
| Titanium dioxide | 5.8 |
| Organic solvent (3) | 2.5 |
| Organic solvent (4) | 12.0 |
| Carboxyl-functional acrylic | 16.1 |
| copolymer dispersion | |
| Acrylic dispersion | 16.1 |
| Dispersant | 1.3 |
| Fluorocarbon modified | 0.6 |
| polyacrylate leveler | |
| Thickener | 0.07 |
| Colorant | 0.02 |
| Part B | |
| Crosslinker | 2.15 |

The properties of the Part A and Part B components were similar to those shown in Table 2, and the properties of the combined Part A and Part B components were similar to those shown in Table 3, except that the VOC (g/L) values for Part A and Combined Part A+Part B were higher than those observed for Example 1 at 180 g/L and 120 g/L respectively, and the density values of both Part A and combined Part A+Part B were higher (e.g., due to the lack of low-density fillers).

Similar to Example (4), test panels were prepared and coated with primer surfacer composition (3). Water immersion (wet adhesion) testing was performed similar to example 4, and test panels coated with the primer surfacer composition (3) exhibited substantially similar results to those observed in Example 4 being 4B (no blister) and 5B (no blister) for Ambient Cure (73° F./23° C.), <25% RH) and Bake (150° F./65° C.; 30-45 min) coatings respectively.

The invention claimed is:

1.-87. (canceled)

88. A primer-surfacer composition, comprising
a primer-surfacer precursor comprising:
a carboxyl-functional polyurethane prepolymer;
a carboxyl-functional acrylic copolymer;
an acrylic, a polyester polyol, or a combination thereof; and
water, and
a crosslinker.

89. The primer-surfacer composition of claim 88, wherein the crosslinker comprises a polyaziridine, a polycarbodiimide, or a combination thereof.

90. The primer-surfacer composition of claim 88, wherein the primer-surfacer composition has a mol % ratio of carboxyl groups to aziridine groups from 1:1.2 to 1.2:1.

91. The primer-surfacer composition of claim 88, wherein the primer-surfacer composition comprises from 1 wt % to 5 wt % of the crosslinker, wherein wt % is based on the total weight of the primer-surfacer composition.

92. The primer-surfacer composition of claim 88, wherein the primer-surfacer precursor comprises:
from 25 wt % to 31 wt % of the carboxyl-functional polyurethane prepolymer,
from 0.8 wt % to 1.1 wt % of a defoamer,
from 5 wt % to 7 wt % of a rheology modifier,
from 3.5 wt % to 4.5 wt % of a dispersant,
from 7 wt % to 9 wt % of an inorganic filler,
from 9 wt % to 12 wt % of a flame retardant,
from 7 wt % to 9 wt % of a pigment,
from 10 wt % to 16 wt % of the carboxyl-functional acrylic copolymer,
from 5 wt % to 10 wt % of the acrylic, the polyester polyol, or the combination thereof;
from 12 wt % to 15 wt % of a low-density filler,
from 0.7 wt % to 0.9 wt % of a wetting/leveling agent, and
from 0.01 wt % to 0.2 wt % of a thickener,
wherein wt % represents the total weight of the solids in the primer-surfacer composition.

93. The primer-surfacer composition of claim 88, wherein the primer-surfacer composition has a VOC less than 180 g/L.

94. The primer-surfacer composition of claim 88, wherein the primer-surfacer composition has a VOC less than 100 g/L.

95. A primer-surfacer coating comprising:
a carboxyl-functional polyurethane prepolymer;
a carboxyl-functional acrylic copolymer;
an acrylic, a polyester polyol, or a combination thereof;
water; and
a crosslinker comprising a polyaziridine, a polycarbodiimide, or a combination thereof.

96. The primer-surfacer coating of claim 95, wherein the primer-surfacer coating exhibits adhesion to a polar polymeric substrate of 4B or 5B determined according to ASTM D3359, Method B, following fluid immersion according to ASTM D1308, humidity exposure according to ASTM D2247, and water immersion test according to ASTM D870.

97. The primer-surfacer coating of claim 95, wherein the primer-surfacer coating exhibits adhesion to a water-based topcoat, a solvent-based basecoat, a solvent-based clearcoat, and/or a solvent-based topcoat of 4B or 5B determined according to ASTM D3359, Method B, following fluid immersion according to ASTM D1308 and humidity exposure according to ASTM D2247.

98. The primer-surfacer coating of claim 95, wherein the primer-surfacer coating has an average thickness from 5 mils (127 μm) to 50 mils (1270 μm).

99. The primer-surfacer composition of claim 95, wherein each of (a) the carboxyl-functional polyurethane prepolymer, (b) the carboxyl-functional acrylic copolymer, and (c) the acrylic, the polyester polyol, or combination thereof, comprise a first part of the primer-surfacer composition, and the crosslinker comprises a second part of the primer-surfacer composition, the first part and the second part forming a two-part primer-surfacer system.

100. A method of coating a substrate comprising:
applying a primer-surfacer composition to a substrate, the primer-surfacer composition comprising:
a carboxyl-functional polyurethane prepolymer;
a carboxyl-functional acrylic copolymer;
an acrylic, a polyester polyol, or a combination thereof;
water; and
a crosslinker, and
curing the applied primer-surfacer composition to provide a primer-surfacer coating.

101. The method of claim 100, wherein the crosslinker comprises a polyaziridine, a polycarbodiimide, or a combination thereof.

102. The method of claim 100, further comprising, after applying the primer-surfacer composition to the substrate and before curing the applied primer-surfacer composition, drying the applied primer-surfacer composition to provide a dried primer-surfacer composition, the drying comprising exposing the applied primer-surfacer composition to a temperature from 20° C. to 25° C. for from 60 minutes to 120 minutes or from 40° C. to 70° C. for from 45 minutes to 60 minutes.

103. The method of claim 100, further comprising, after curing the applied primer-surfacer composition to provide a cured primer-surfacer coating, mechanically abrading the cured primer-surfacer coating to provide a leveled surface.

104. The method of claim 100, wherein the leveled surface comprises a surface of a part made using additive manufacturing.

105. The method of claim 100, wherein applying the primer-surfacer composition comprises spraying, rolling, or squeezing.

106. The method of claim 100, further comprising:
applying a coating overlying the primer-surfacer coating; and
curing the overlying coating.

107. The method of claim 106, wherein the overlying coatings comprises a solvent based coating or a water-based coating.
